(19) United States
(12) Patent Application Publication
(10) Pub. No.: US 2013/0031469 A1
(43) Pub. Date: Jan. 31, 2013

(54) WEB-CONTENT CONVERSION DEVICE, WEB-CONTENT CONVERSION METHOD AND RECORDING MEDIUM

(71) Applicant: Shujun Yoshizaka, Tokyo (JP)

(72) Inventor: Shujun Yoshizaka, Tokyo (JP)

(73) Assignee: NEC CORPORATION, Tokyo (JP)

(21) Appl. No.: 13/639,725

(22) PCT Filed: Mar. 7, 2011
(86) PCT No.: PCT/JP2011/055854

§ 371 Date: Oct. 5, 2012

(30) Foreign Application Priority Data
Apr. 9, 2010 (JP) 2010-090522

(51) Int. Cl. G06F 17/00

(52) U.S. Cl. 715/239

(57) ABSTRACT

An expression of an instruction provided for understanding and operating Web-content is converted to the expression which shows the meaning corresponding to the Web-content appropriately. A Web-content conversion apparatus links and stores in a storage unit a figure-symbol-character which is a symbol-character representing a figure and a character string after conversion which is a character string representing the meaning of the figure-symbol-character; among elements which are included in an inputted Web-content, and in case a figure-symbol-character is included in content instruction information which shows contents of the element including a predetermined markup tag or an attribute value of an attribute which the predetermined markup tag includes, reads the character string after conversion which is made to correspond to the figure-symbol-character from the storage unit; and for each element included in the Web-content and including the content instruction information including a figure-symbol-character, by using replacement information which is information which added the character string after conversion read based on the figure-symbol-character which is included in the content instruction information included in the element to at least part of the element, replaces the element.

### TECHNICAL FIELD

The present invention relates to a technology which converts Web-content including a figure-symbol-character which is a symbol-character representing a figure.

### BACKGROUND ART

There exists WCAG (Web Contents Accessibility Guideline) 2.0 (non-patent document 1 and non-patent document 2) which is a guideline W3C (World Wide Web Consortium) recommends. This guideline is a guideline for creating Web-content considering people with disabilities or aged people. According to WCAG 2.0, there is “Success Criterion 1.3.3 Sensory Characteristics” which is a success criterion for making the Web-content considering people with disabilities or aged people. This success criterion specifies a criterion which says “Instructions provided for understanding and operating content do no rely solely on sensory characteristics of components such as shape, size, visual location, orientation, or sound”. The intent of this success criterion is to ensure that “All users can access instructions for using the content, even when they cannot perceive shape or size or use information about spatial location or orientation”.

As related technologies for providing to a user Web-content considering people with disabilities or aged people, for example, there are following technologies. The technology described in patent document 1 is the technology which examines the contents of a text and specifies an appropriate voice read aloud method. Further, the technology described in patent document 2 is the technology which stores in advance a disabilities characteristics parameter which modeled each symptom which a person with disabilities has and performs conversion processing of Web-content according to the characteristics characteristics parameter.

### PRECEDING TECHNICAL LITERATURE

### Patent Document

Patent document 1 Japanese Patent Application Laid-Open No. 1999-305987.

Patent document 2 Japanese Patent Application Laid-Open No. 2009-70079.

### Non-Patent Document

Non-patent document 1 W3C (World Wide Web Consortium) WCAG (Web Contents Accessibility Guideline), the internet <http://www.w3.org/TR/WCAG20/>, [searched on Apr. 8, 2010].

Non-patent document 2 WCAG 2.0 manual, the internet <http://wwwjsa.orjp/stdz/instac/commitee-acc/W3C-WCAG/WCAG20/UNDERSTAN DING-WCAG20/index.html#contents w3.org/TR/WCAG20/>, [searched on Apr. 8, 2010].

### BRIEF SUMMARY OF THE INVENTION

Problems to be Solved by the Invention

The related technology described in patent document 1 is a method which, by a voice read aloud means determining a text part out of an inputted text, reads aloud the contents correctly. Accordingly, the related technology described in patent document 1 cannot convert an expression of an instruction provided for understanding and operating Web-content to an expression which shows the meaning related to the content appropriately. This is because the related technology described in patent document 1 converts the expression of the text regardless of whether the text is an instruction about the Web-content or not, and does not consider whether the expression after conversion is the expression related to the content. Also, the related technology described in patent document 1 does not consider a case in which the meaning is different between a case when the text is an instruction about the Web-content and a case when the text is not an instruction about the Web-content. Accordingly, the related technology described in patent document 1 cannot convert the expression of the instruction provided for understanding and operating the Web-content to the expression which shows the meaning related to the content appropriately.

The related technology described in patent document 2 is a method to convert Web-content according to the characteristics of a person with disabilities. However, in case an expression of an instruction provided for understanding and operating the Web-content makes it difficult to transmit the meaning which the expression has, the expression itself of the instruction does not make the transmission of the meaning difficult resulting from the characteristics of the person with disabilities. Accordingly, in case the expression of the instruction provided for understanding and operating the Web-content makes it difficult to transmit the meaning of the expression, the related technology described in patent document 2 cannot convert the expression of the instruction to the expression which shows the meaning related to the content appropriately.

### Object of the Invention

One of the objects of the present invention is to solve the problems mentioned above and to provide a Web-content conversion apparatus, a Web-content conversion method and a recording medium which convert an expression of an instruction provided for understanding and operating Web-content to an expression which shows the meaning related to the Web-content appropriately.

### Means for Solving the Problems

A first Web-content conversion apparatus according to one mode of the present invention includes: a figure-symbol-character conversion correspondence relation storage unit which links and stores a figure-symbol-character which is a symbol-character representing a figure and a character string after conversion which is a character string representing the meaning of the figure-symbol-character concerned; a Web-content analysis unit which, among elements which are included in an inputted Web-content, and in case a figure-symbol-character is included in content instruction information which shows contents of the element including a predetermined markup tag or an attribute value of an attribute which the predetermined markup tag includes, reads the character string after conversion which is made to correspond to the figure-symbol-character concerned from the figure-symbol-character conversion correspondence relation storage unit; and a Web-content conversion unit which, for each element included in the Web-content and including the content instruction information including a figure-symbol-character, by using replacement information which is information which added the character string after conversion which the Web-content analysis unit read based on the figure-symbol-character which is included in the content instruction information included in the element to at least part of the element, and by replacing the element concerned, converts the Web-content to Web-content after conversion.

A first Web-content conversion method according to one mode of the present invention includes: linking and storing in a storage unit a figure-symbol-character which is a symbol-character representing a figure and a character string after conversion which is a character string representing the meaning of the figure-symbol-character concerned; among elements which are included in an inputted Web-content, and in case a figure-symbol-character is included in content instruction information which shows contents of the element including a predetermined markup tag or an attribute value of an attribute which the predetermined markup tag includes, reading the character string after conversion which is made to correspond to the figure-symbol-character concerned from the storage unit; and for each element included in the Web-content and including the content instruction information including a figure-symbol-characters, by using replacement information which is information which added the character string after conversion read based on the figure-symbol-character which is included in the content instruction information included in the element to at least part of the element, and by replacing the element concerned, converting the Web-content to Web-content after conversion.

A first Web-content conversion program according to one mode of the present invention makes a computer execute processing comprising; processing which links and stores in a storage unit a figure-symbol-character which is a symbol-character representing a figure and a character string after conversion which is a character string representing the meaning of the figure-symbol-character concerned; processing which, among elements which are included in an inputted Web-content, and in case a figure-symbol-character is included in content instruction information which shows contents of the element including a predetermined markup tag or an attribute value of an attribute which the predetermined markup tag includes, reads the character string after conversion which is made to correspond to the figure-symbol-character concerned from the storage unit; and processing which, for each element included in the Web-content and including the content instruction information including a figure-symbol-characters, by using replacement information which is information which added the character string after conversion read based on the figure-symbol-character which is included in the content instruction information included in the element to at least part of the element, and by replacing the element concerned, converts the Web-content to Web-content after conversion.

### Effect of the Invention

One of the effects of the present invention is to be able to convert an expression of an instruction provided for understanding and operating Web-content to an expression which shows the meaning related to the Web-content appropriately.

### BRIEF DESCRIPTION OF THE DRAWINGS

FIG. 1 is a block diagram showing a structure of a Web-content conversion apparatus according to the first exemplary embodiment of the present invention.

FIG. 2 is an example which shows information stored in a figure-symbol-character conversion correspondence relation storage unit according to the first exemplary embodiment of the present invention.

FIG. 3 is a figure showing an example of examination result information.

FIG. 4 is a block diagram showing an exemplary configuration in which a Web-content conversion apparatus according to the first exemplary embodiment of the present invention includes a figure-symbol-character storage unit 102.

FIG. 5 is a figure showing an example of conversion result information generated by a first conversion method of a Web-content conversion apparatus according to the first exemplary embodiment of the present invention.

FIG. 6 is a figure showing an example of conversion result information generated by a second conversion method of a Web-content conversion apparatus according to the first exemplary embodiment of the present invention.

FIG. 7 is a figure showing an example of conversion result information generated by a third conversion method of a Web-content conversion apparatus according to the first exemplary embodiment of the present invention.

FIG. 8 is a figure showing an example of conversion result information generated by a fourth conversion method of a Web-content conversion apparatus according to the first exemplary embodiment of the present invention.

FIG. 9 is a flow chart showing an example of an outline of operation of a Web-content conversion apparatus according to the first exemplary embodiment of the present invention.

FIG. 10 is a block diagram showing a structure of a Web-content conversion apparatus according to the second exemplary embodiment of the present invention.

FIG. 11 is a figure showing an example of examination result information which a relevant part output unit according to the second exemplary embodiment of the present invention outputs.

FIG. 12 is a figure showing an example of conversion result information which a relevant part output unit according to the second exemplary embodiment of the present invention outputs.

FIG. 13 is a flow chart showing an example of an outline of operation of a Web-content conversion apparatus according to the second exemplary embodiment of the present invention.

FIG. 14 is an example of display in case a Web-content conversion apparatus according to the second exemplary embodiment of the present invention displays a Web-content and a Web-content after conversion by a web browser.

FIG. 15 is a block diagram showing a structure of a Web-content conversion apparatus according to the third exemplary embodiment of the present invention.

FIG. 16 is an example which shows information stored in a figure-symbol-character conversion correspondence relation storage unit according to the third exemplary embodiment of the present invention.

FIG. 17 is a figure showing an example of rule selection information which a Web-content analysis unit according to the third exemplary embodiment of the present invention stores.

FIG. 18 is a figure showing an example of information which a relevant part output unit according to the third exemplary embodiment of the present invention outputs.

FIG. 19 is a flow chart showing an example of an outline of operation of a Web-content conversion apparatus according to the third exemplary embodiment.

### MODE FOR CARRYING OUT THE INVENTION

Next, a mode for carrying out the invention will be described in detail with reference to drawings. Further, in each figure and in each exemplary embodiment described in the specification, same code is given to a component including the same function.

### The First Exemplary Embodiment

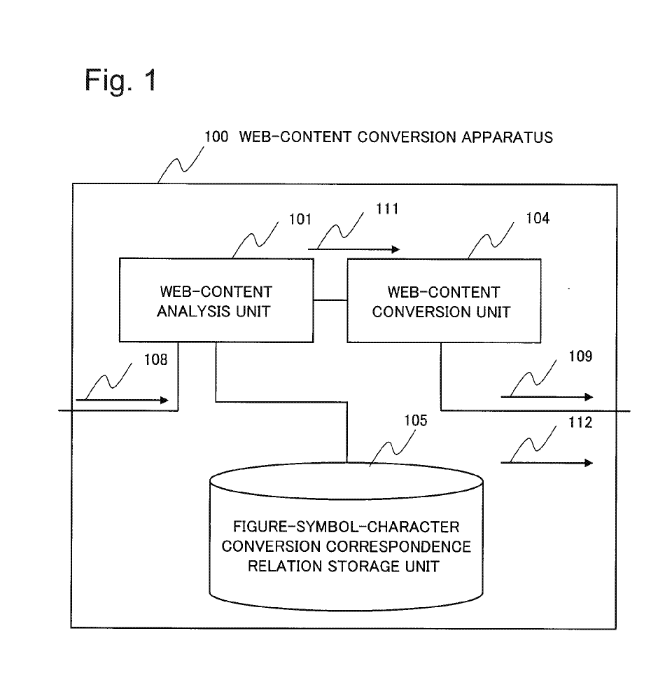

FIG. 1 is a block diagram showing a structure of a Web-content conversion apparatus 100 according to the first exemplary embodiment of the present invention.

Referring to FIG. 1, the Web-content conversion apparatus 100 according to the first exemplary embodiment of the present invention includes: a Web-content analysis unit 101, a Web-content conversion unit 104 and a figure-symbol-character conversion correspondence relation storage unit 105 (applicant footnote when translated: hereinafter, abbreviated as “correspondence relation storage unit 105” for convenience sake of a translation expression). The Web-content analysis unit 101 is connected with the Web-content conversion unit 104 and the correspondence relation storage unit 105 respectively. The Web-content conversion unit 104 is connected with the Web-content analysis unit 101. The correspondence relation storage unit 105 is connected with the Web-content analysis unit 101.

===Correspondence Relation Storage Unit 105===

The correspondence relation storage unit 105 links and stores a figure-symbol-character and a character string after conversion which is a character string representing the meaning of the figure-symbol-character.

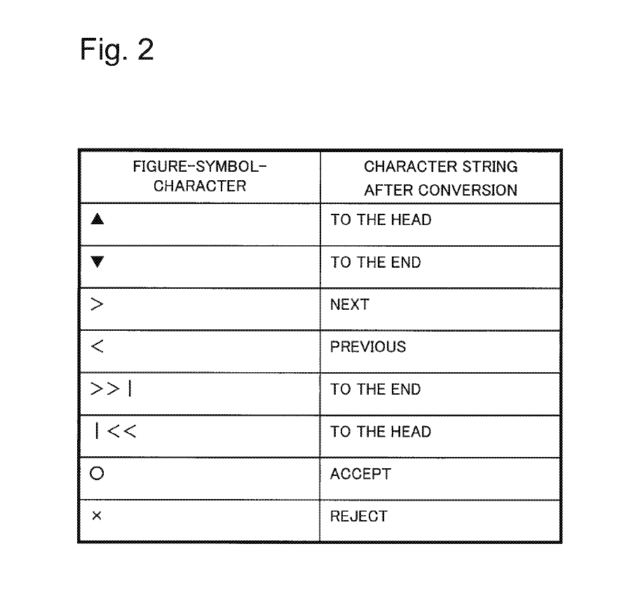

FIG. 2 is an example which shows information stored in the correspondence relation storage unit 105. The figure-symbol-character is a symbol-character representing a figure. For example, the figure-symbol-character includes: symbol-characters representing shape such as “o”, “”, “x”, “□”, “▪”, and symbol-characters representing orientation such as “←”, “→”, “↑”, “↓”, “▴”, “▾”, “̂”, “\check{}”, “|<<”, “<”, “>”, “>>|”, “<-”, “->”. These figure-symbol-characters are illustrations at most, and the figure-symbol-character is not limited to the symbol-characters mentioned above. For example, the figure-symbol-character may be a character string including symbol-characters of no smaller than 2 or may include a two-byte symbol-character and a single-byte symbol-character.

The character string after conversion is a character string representing the meaning of the figure-symbol-character which is made to correspond. For example, as the character string after conversion which is made to correspond to the figure-symbol-character “o”, “correct”, “OK”, “accept” or “good” can be mentioned.

Referring to FIG. 2, for example, the correspondence relation storage unit 105 links and stores the figure-symbol-character “▴” and the character string after conversion “to the head”.

===Web-Content Analysis Unit 101===

First, the Web-content analysis unit 101 receives Web-content 108 which is an examination target from outside. And the Web-content analysis unit 101 determines whether content instruction information 110 is included in the received Web-content 108.

As the Web-content 108, for example, a document described by a markup language (Markup Language) can be mentioned. Concretely, the Web-content 108 includes content described by a language such as an HTML (HyperText Markup Language) and an XHTML (Extensible HyperText Markup Language).

The content instruction information 110 is the information included in a prescribed part of the Web-content 108 and including an instruction for understanding at least part of the content. Also, the content instruction information 110 is the information including an instruction for operating the content.

The prescribed part of the Web-content 108 mentioned above is a part including a function to instruct at least part of elements included in the Web-content 108. Concretely, as this prescribed part, for example, contents (text) of the element including a predetermined markup tag which is included in a file described by a markup language, or a part which shows an attribute value of an attribute which a predetermined markup tag included in the file mentioned above can be mentioned.

In case the Web-content 108 is a file described by the HTML, the prescribed part mentioned above falls under, for example, the parts mentioned below.
A part of “<a>-</a>” which is an element representing a link.
A part of “<input type=“submit” value=“-”>” which is an attribute value included in a markup tag which an element representing a send button includes.

A part of “<select . . . ><option>-</option></select>” which is an element representing a selection box.

A part of “<input type=“radio” value=“. . . ”>-</input>” which is an element representing a radio button.

A part of “<table summary=“-”>” which is an attribute value included in a markup tag which an element representing a table includes.

The above is an illustration and the prescribed part of the Web-content 108 is not limited to the part enumerated above.

A user of this Web-content conversion apparatus 100 may make the Web-content analysis unit 101 store information for specifying the prescribed part of the Web-content 108 mentioned above in advance. For example, the Web-content analysis unit 101 may store the information which specifies a predetermined markup tag (for example, information such as “a; input; button . . . ”). Or the Web-content analysis unit 101 may store the information which specifies an attribute which a predetermined markup tag includes (for example, information such as “value attribute in input tag”)

Second, in case it is determined that the content instruction information 110 is included in the Web-content 108, the Web-content analysis unit 101 determines whether a figure-symbol-character is included in each of the content instruction information 110.

The Web-content analysis unit 101 determines whether a figure-symbol-character stored in the correspondence relation storage unit 105 corresponds to each character included in each of the content instruction information 110. And in case it is determined that the figure-symbol-character is included in the content instruction information 110, the Web-content analysis unit 101 generates examination result information 111.

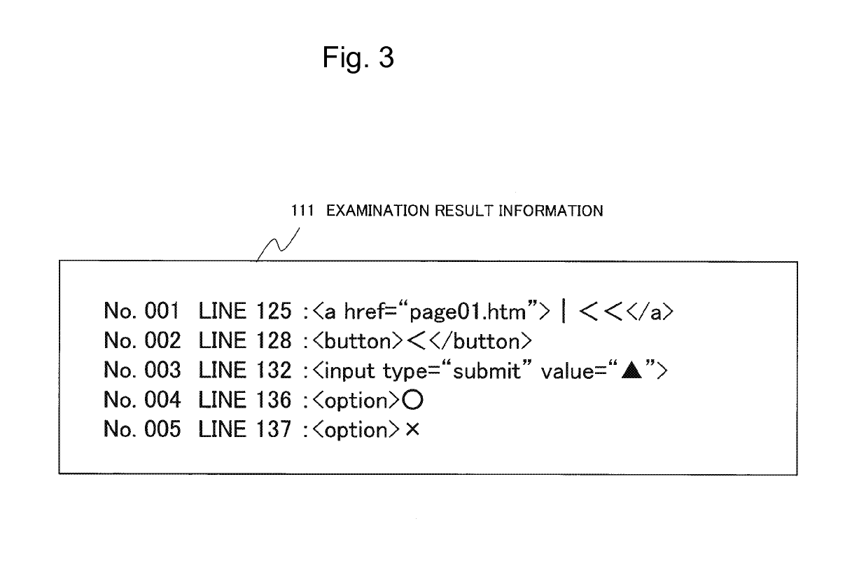

Here, the examination result information 111 is the information which makes information which can specify a location within the Web-content 108 of an element in which the content instruction information 110 is included and the element which includes the content instruction information 110 correspond and includes them. FIG. 3 is an example which shows an example of the examination result information 111. Referring to FIG. 3, as the information which can specify a location within the Web-content 108 of an element including the content instruction information 110, the examination result information 111 includes a number of the line of the code of the Web-content 108 (for example, “line 125”). Also, the examination result information 111 includes an element including the content instruction information 110 (for example, ‘<a href=“page01.htm”>|<<</a>’). The examination result information 111 may include an identifier (for example, “No.001”) which can identify each element which the examination result information 111 includes.

For each figure-symbol-character which is included in the content instruction information 110 included in each element included in the examination result information 111, the Web-content analysis unit 101 reads a character string after conversion which is made to correspond to the figure-symbol-character from the correspondence relation storage unit 105. For example, referring to FIG. 2 and FIG. 3, based on a figure-symbol-character “|<<” which is included in the element ‘<a href=“page01.htm”>|<<</a>’ described in No.001 of the examination result information 111 of FIG. 3, the Web-content analysis unit 101 reads a character string after conversion “to the head” which is made to correspond to “|<<” in FIG. 2. And the Web-content analysis unit 101 provides the Web-content 108, the read character string after conversion and the examination result information 111 to the Web-content conversion unit 104 mentioned below.

Further, the Web-content analysis unit 101 links a character string after conversion for each figure-symbol-character which is included in the content instruction information 110 included in each element included in the examination result information 111. And the Web-content analysis unit 101 provides the character string after conversion which is made to correspond and the examination result information 111 to the Web-content conversion unit 104.

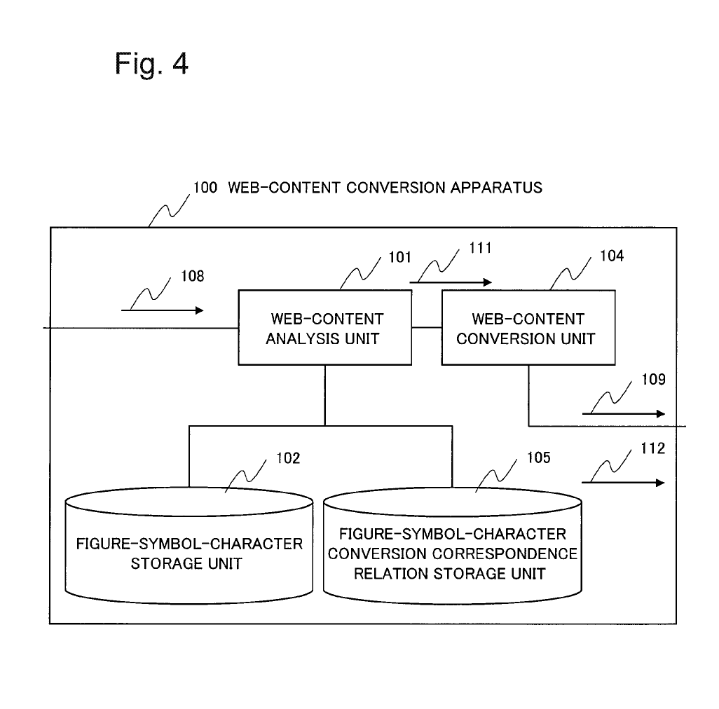

Here, the Web-content conversion apparatus 100 may include a figure-symbol-character storage unit 102 storing a figure-symbol-character. FIG. 4 is a block diagram showing an exemplary configuration in which the Web-content conversion apparatus 100 includes the figure-symbol-character storage unit 102. The figure-symbol-character storage unit 102 is connected with the Web-content analysis unit 101. In this case, the Web-content analysis unit 101 may determine whether the figure-symbol-character stored in the figure-symbol-character storage unit 102 corresponds to each character included in the content instruction information 110.

===Web-Content Conversion Unit 104===

The Web-content conversion unit 104 receives the Web-content 108, a character string after conversion and the examination result information 111 from the Web-content analysis unit 101. And the Web-content conversion unit 104 performs conversion which adds at least part of the character string after conversion to at least part of the element of the Web-content 108 in which the content instruction information 110 is included based on the received examination result information 111. The Web-content conversion unit 104 performs the conversion mentioned above for each element of the Web-content 108 corresponding to the element included in the examination result information 111 respectively. The Web-content 108 converted by the Web-content conversion unit 104 is represented as Web-content after conversion 109.

The Web-content conversion unit 104 outputs conversion result information 112 mentioned below and the Web-content after conversion 109. The conversion result information 112 is the information in which, for each element included in the examination result information 111, the character string after conversion which is read from the correspondence relation storage unit 105 based on the figure-symbol-character included in the content instruction information 110 included in the element is made to correspond.

For example, the conversion mentioned above may be the following methods. However, the following methods are illustrations, and the conversion mentioned above is not limited to the following methods. The Web-content conversion unit 104 generates the Web-content after conversion 109 by converting the Web-content 108 using at least one of the first to the fourth conversion method or a conversion method which combines them.

(The First Conversion Method)

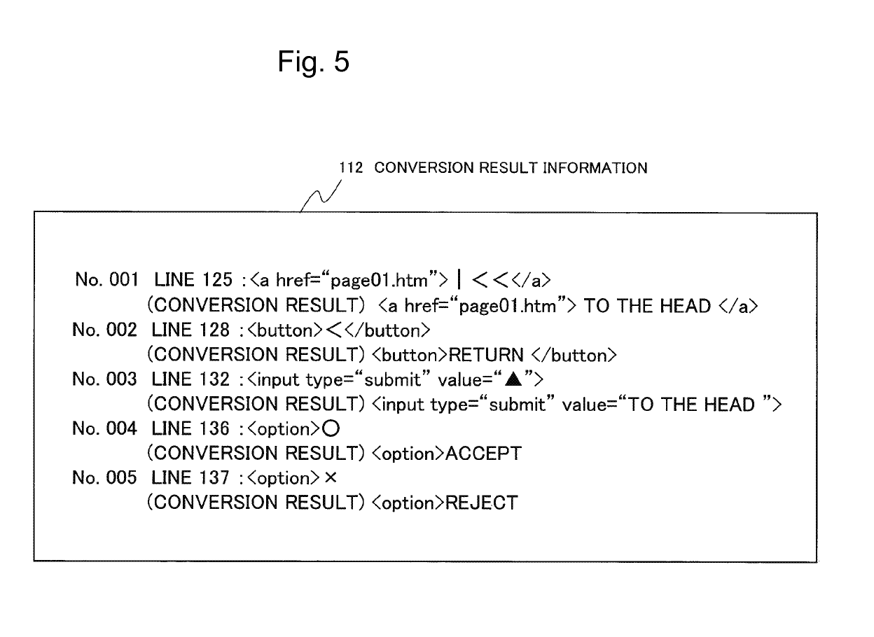

The Web-content conversion unit 104 may replace the figure-symbol-character which is included in the content instruction information 110 included in each element of the Web-content 108 by the character string after conversion which is made to correspond to the figure-symbol-character. FIG. 5 is an example of the conversion result information 112 outputted when the Web-content conversion unit 104 carries out conversion by the first conversion method. Referring to FIG. 5, according to the first conversion method, for example, the figure-symbol-character “|<<” included in the Web-content 108 is replaced by the character string after conversion “to the head”.

(The Second Conversion Method)

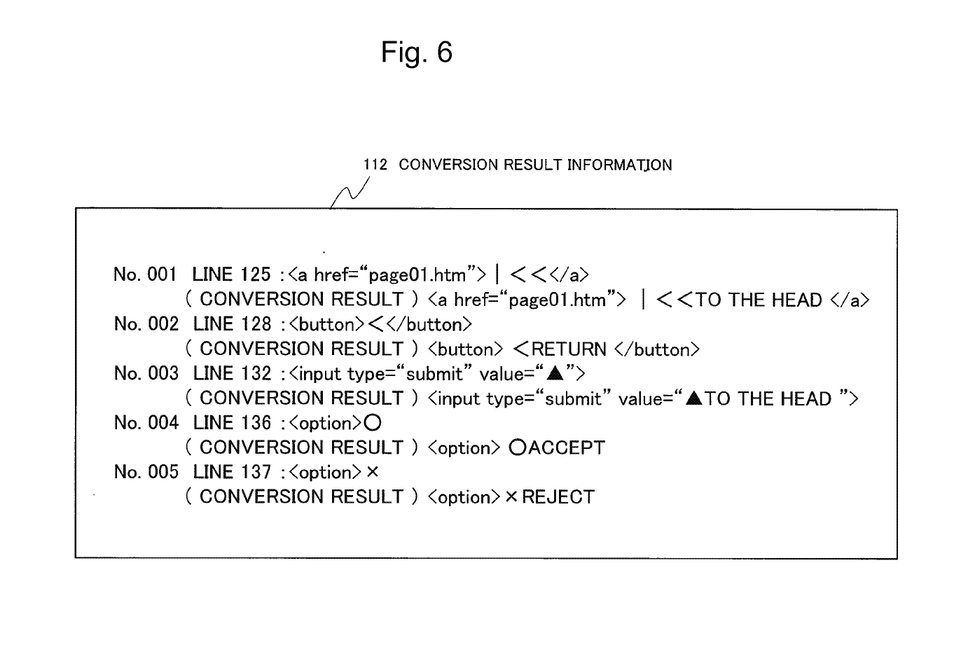

The Web-content conversion unit 104 may write the figure-symbol-character which is included in the content instruction information 110 included in each element of the Web-content 108 along with the character string after conversion which is made to correspond to the figure-symbol-character. FIG. 6 is an example of the conversion result information 112 outputted when the Web-content conversion unit 104 carries out conversion by the second conversion method. Referring to FIG. 6, according to the second conversion method, for example, the figure-symbol-character “|<<” included in the Web-content 108 is written along with the character string after conversion “to the head”.

(The Third Conversion Method)

The Web-content conversion unit 104 may write the figure-symbol-character which is included in the content instruction information 110 included in each element of the Web-content 108 along with the character string after conversion which is made to correspond to the figure-symbol-character as an alternative text.

Here, the alternative text is a text which shows a function, meaning or purpose of a non-text content included in the Web-content 108. According to WCAG 2.0, in the item “Success Criterion 1.1.1 Non-text Content”, there exists a criterion that “All non-text content that is presented to the user has a alternative text that serves the equivalent purpose”. The intent of this criterion is: “Providing alternative texts allows the information to be rendered in a variety of ways by a variety of user agents. For example, a person who cannot see a picture can have the alternative text read aloud using synthesized speech. A person who cannot hear an audio file can have the alternative text displayed so that he or she can read it”. The alternative text according to this exemplary embodiment means the alternative text specified by WCAG 2.0.

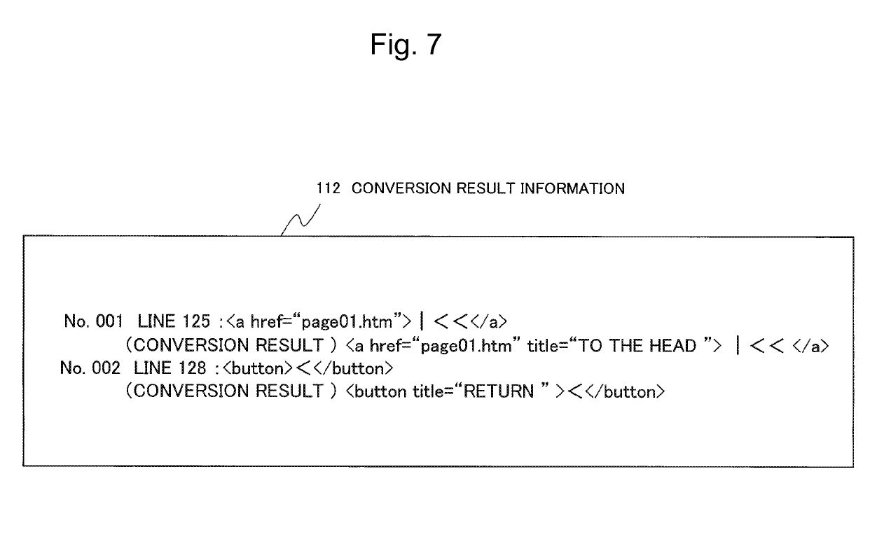

The Web-content conversion unit 104 performs the conversion mentioned above by adding the character string after conversion as the alternative text to an element of a markup tag including the content instruction information 110 included in each element. FIG. 7 is an example of the conversion result information 112 outputted when the Web-content conversion unit 104 carries out conversion by the third conversion method. Referring to FIG. 7, according to the third conversion method, for example, the alternative text “to the head” which is the character string after conversion is added to the element “<a>” of the markup tag including the content instruction information 110 as the attribute value of the title attribute. The title attribute is an attribute used in order to add supplementary information to the element of the markup tag.

(The Fourth Conversion Method)

The Web-content conversion unit 104 may write the figure-symbol-character which is included in the content instruction information 110 included in each element of the Web-content 108 along with the character string after conversion which is made to correspond to the figure-symbol-character as a ruby.

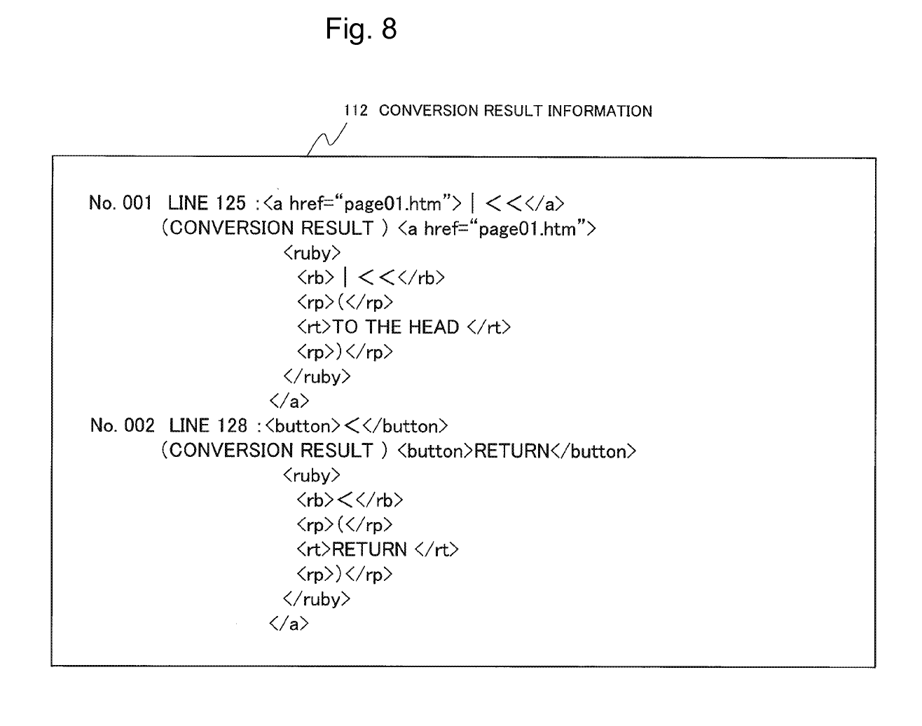

The Web-content conversion unit 104 performs the conversion mentioned above as follows. First, the Web-content conversion unit 104 generates an element including a markup tag which shows a target of a ruby. The Web-content conversion unit 104 adds the figure-symbol-character which is included in the content instruction information 110 included in each element of the Web-content 108 as the contents. Second, the Web-content conversion unit 104 generates an element including a markup tag which is made to correspond to the figure-symbol-character mentioned above and which shows a text of the ruby. The Web-content conversion unit 104 adds the character string after conversion as the contents. By the operation mentioned above, the Web-content conversion unit 104 performs the conversion mentioned above. FIG. 8 is an example of the conversion result information 112 outputted when the Web-content conversion unit 104 carries out conversion by the fourth conversion method. Referring to FIG. 8, according to the fourth conversion method, for example, the figure-symbol-character “|<<” included in the Web-content 108 is included in the markup tag “<rb>” which shows the target of the ruby. Further, the character string after conversion “to the head” is made to correspond to the figure-symbol-character mentioned above, and included in the markup tag “<rt>” which shows the text of the ruby.

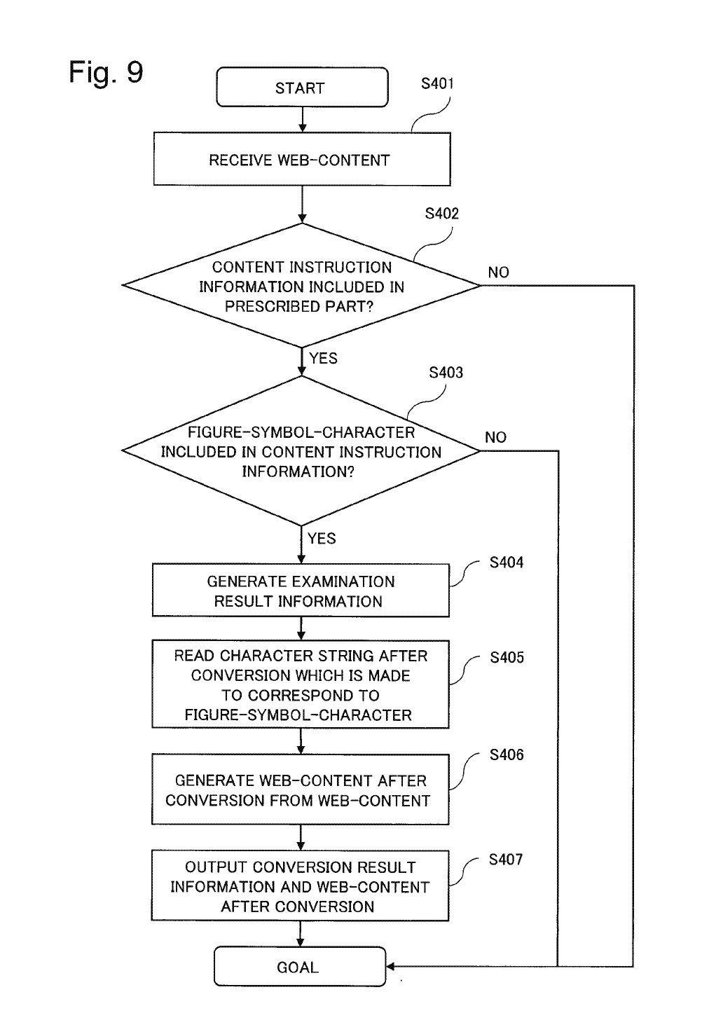

FIG. 9 is a flow chart showing an example of an outline of operation of the Web-content conversion apparatus 100 according to the first exemplary embodiment of the present invention.

First, the Web-content analysis unit 101 receives the Web-content 108 (Step S401). And the Web-content analysis unit 101 determines presence of the content instruction information 110 which is included in the prescribed part of the received Web-content 108 (Step S402).

In case it is determined that the content instruction information 110 is included in the prescribed part of the Web-content 108 (“Yes” in Step S402), the Web-content analysis unit 101 carries out the following processing. That is, the Web-content analysis unit 101 determines whether a figure-symbol-character is included in each of the content instruction information 110 (Step S403). On the other hand, in case the Web-content analysis unit 101 determines that the content instruction information 110 is not included in the prescribed part of the Web-content 108 (“No” in Step S402), the Web-content conversion apparatus 100 ends the processing.

In case it is determined that a figure-symbol-character is included in the content instruction information 110 (“Yes” in Step S403), the Web-content analysis unit 101 generates the examination result information 111 mentioned above (Step S404). And the processing of the Web-content conversion apparatus 100 proceeds to Step S405. On the other hand, in case it is determined that a figure-symbol-character is not included in any of the content instruction information 110 (“No” in Step S403), the Web-content conversion apparatus 100 ends the processing.

For each figure-symbol-character included in the examination result information 111 mentioned above, the Web-content analysis unit 101 reads the character string after conversion which is made to correspond to the figure-symbol-character from the correspondence relation storage unit 105 (Step S405).

The Web-content conversion unit 104 receives the Web-content 108, the character string after conversion and the examination result information 111 from the Web-content analysis unit 101. And the Web-content conversion unit 104 performs conversion which adds the character string after conversion to at least part of the element of the Web-content 108 in which the content instruction information 110 is included based on the received examination result information 111 (Step S406). By this conversion, the Web-content conversion unit 104 generates the Web-content after conversion 109 based on the Web-content 108.

For each of the content instruction information 110 which is included in the element included in the examination result information 111, the Web-content conversion unit 104 generates the conversion result information 112 which is the information which made the corresponding character string after conversion correspond to the figure-symbol-character included in the content instruction information 110. And the Web-content conversion unit 104 outputs the conversion result information 112 mentioned above and the Web-content after conversion 109 (Step S407).

The Web-content conversion apparatus 100 according to the first exemplary embodiment determines whether a figure-symbol-character representing a figure is included in the content instruction information 110 which is the information which instructs contents or operation of the content included in the part of the Web-content 108. And in case a figure-symbol-character is included in the information mentioned above, the Web-content conversion apparatus 100 adds to at least part of the element in which the figure-symbol-character is included, the character string after conversion which is the character string which shows the meaning of the figure-symbol-character concerned. By this conversion, the Web-content conversion apparatus 100 converts the Web-content 108 to the Web-content after conversion 109.

For example, there is a case when a character which does not satisfy “Success Criterion 1.3.3 Sensory Characteristics” in the WCAG 2.0, for example, “→”, “>” or “->”, may be included in the content instruction information 110. In this case, in the related technology, the Web-content 108 cannot deliver the meaning correctly to a person with visual disabilities. There are cases when, a symbol-character such as “→”, “>” or “->” may have intent, for example, such as “to the next item” or “to the next page”. However, in case a person who cannot depend on sight uses this Web-content 108 using a voice read aloud means, there is a possibility that this voice read aloud means may skip each symbol-character mentioned above. Or, there is a possibility that this voice read aloud means reads aloud each of the symbol-character mentioned above as “right arrow”, “more than”, or “hyphen more than”. “Right arrow” is an expression dependent on “orientation”. Also, an expression such as “more than” is an expression which does not show even orientation.

Also, for example, there is a case when a symbol-character such as “|<<” may be used in the meaning such as “return to the head” or “return to the beginning of the page”. However, in case a person with visual disabilities uses this Web-content 108 using the voice read aloud means, there is a possibility that the result of reading aloud by the voice read aloud means may be “pipeline, less than, less than”. For the person with visual disabilities, to guess from only the voice information which says “pipeline, less than, less than” the meaning which says “return to the head” results in depending on the user's experience or knowledge, and there is a possibility that transmission of the meaning will be made difficult.

On the other hand, in case, for example, “→”, “>” or “->” are included, the Web-content conversion apparatus 100 according to the first exemplary embodiment adds information which says “next” to the part including these characters. In case the person with visual disabilities uses this Web-content after conversion 109 using the voice read aloud means, this voice read aloud means reads aloud “next” which is the character string after conversion about the part of each symbol-character mentioned above. As a result, the person with visual disabilities can understand that the content which shows operation to proceed to the next is included.

Accordingly, the Web-content conversion apparatus 100 according to the first exemplary embodiment can convert an expression of an instruction provided for understanding and operating Web-content to an expression which shows the meaning related to the Web-content appropriately.

Also, the Web-content conversion apparatus 100 according to the first exemplary embodiment determines whether a figure-symbol-character is included in a prescribed part of the Web-content 108, not in all parts of the Web-content 108. In this case, the Web-content conversion apparatus 100 makes, among the Web-content 108, a part which includes a function to instruct at least a part of content included in the Web-content 108 a target of determination. As a result, the Web-content conversion apparatus 100 according to the first exemplary embodiment can convert the expression of the instruction provided for understanding and operating the Web-content to the expression which shows the meaning related to the Web-content appropriately. For example, there is a case when, in the Web-content 108, an expression such as “x<80” may be included in a main text of the Web-content 108 (for example, contents of an element of a <p>markup tag). Even in such a case, the Web-content conversion apparatus 100 can determine the expression such as “x<80” as not “an expression of an instruction provided for understanding and operating Web-content”. This is because the expression is included in a part which is not a part including a function to instruct at least part of content included in the Web-content 108.

### The Second Exemplary Embodiment

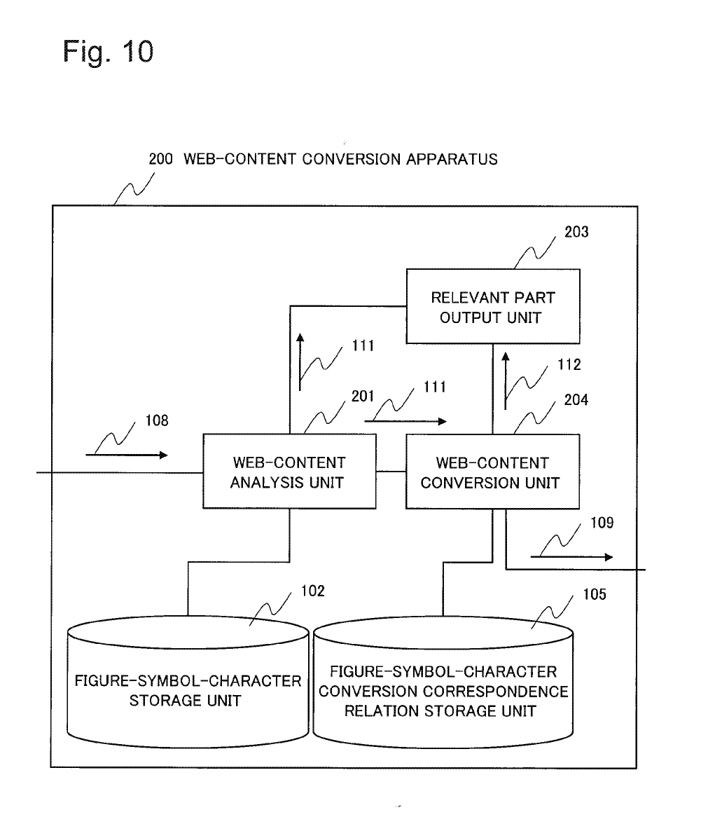

FIG. 10 is a block diagram showing a structure of a Web-content conversion apparatus 200 according to the second exemplary embodiment of the present invention.

Referring to FIG. 10, the Web-content conversion apparatus 200 according to the second exemplary embodiment of the present invention includes a Web-content analysis unit 201, the figure-symbol-character storage unit 102, a relevant part output unit 203, a Web-content conversion unit 204 and the correspondence relation storage unit 105. The Web-content analysis unit 201 is connected with the figure-symbol-character storage unit 102, the relevant part output unit 203 and the Web-content conversion unit 204 respectively. The figure-symbol-character storage unit 102 is connected with the Web-content analysis unit 201. The relevant part output unit 203 is connected with the Web-content analysis unit 201 and the Web-content conversion unit 204 respectively. The Web-content conversion unit 204 is connected with the Web-content analysis unit 201, the relevant part output unit 203 and the correspondence relation storage unit 105 respectively. The correspondence relation storage unit 105 is connected with the Web-content conversion unit 204.

===Figure-Symbol-Character Storage Unit 102===

The figure-symbol-character storage unit 102 is same as the figure-symbol-character storage unit 102 according to the first exemplary embodiment.

===Correspondence Relation Storage Unit 105===

The correspondence relation storage unit 105 is same as the correspondence relation storage unit 105 according to the first exemplary embodiment.

===Web-Content Analysis Unit 201===

The Web-content analysis unit 201 carries out the following operation same as the Web-content analysis unit 101 according to the first exemplary embodiment. First, the Web-content analysis unit 201 determines presence of the content instruction information 110 which is included in a prescribed part of the received Web-content 108.

Second, in case it is determined that the content instruction information 110 is included in the prescribed part of the Web-content 108, the Web-content analysis unit 201 determines whether a figure-symbol-character is included in each of the content instruction information 110. In this case, the Web-content analysis unit 201 determines whether a figure-symbol-character stored in the figure-symbol-character storage unit 102 corresponds to each character included in the content instruction information 110.

Concretely, whenever it is determined that there is a figure-symbol-character in the content instruction information 110 in the prescribed part of the Web-content 108, the Web-content analysis unit 201 carries out the following processing. That is, the Web-content analysis unit 201 links the content instruction information 110 which is determined to include a figure-symbol-character and the information which shows the prescribed part mentioned above, and stores them as the examination result information 111. This examination result information 111 is same as the examination result information 111 according to the first exemplary embodiment.

In case it is determined that a figure-symbol-character is included in the content instruction information 110, the Web-content analysis unit 201 provides the Web-content 108 and the examination result information 111 to the Web-content conversion unit 204 mentioned below.

Also, the Web-content analysis unit 201 provides the examination result information 111 mentioned above to the relevant part output unit 203 mentioned below.

===Web-Content Conversion Unit 204===

The Web-content conversion unit 204 receives the Web-content 108 and the examination result information 111 from the Web-content analysis unit 201. And the Web-content conversion unit 204 performs the following processing for each element of the Web-content 108 corresponding to each element which is included in the received examination result information 111 respectively. That is, the Web-content conversion unit 204 reads a character string after conversion which is made to correspond to the figure-symbol-character included in the content instruction information 110 included in the respective elements mentioned above from the correspondence relation storage unit 105 respectively. And the Web-content conversion unit 204 performs conversion which adds the read character string after conversion to at least part of the element mentioned above. The method of this conversion may be same as in the first exemplary embodiment.

Also, the Web-content conversion unit 204 performs the following processing for each element which is included in the received examination result information 111. That is, the Web-content conversion unit 204 provides the conversion result information 112 which is the information which made replacement information mentioned below correspond to the respective elements mentioned above respectively to the relevant part output unit 203 mentioned below. The replacement information is the character string after conversion which the Web-content conversion unit 204 read from the correspondence relation storage unit 105 based on the figure-symbol-character which the content instruction information 110 included in the corresponding element includes.

And the Web-content conversion unit 204 outputs the Web-content after conversion 109 which is generated by converting the Web-content 108.

===Relevant Part Output Unit 203===

The relevant part output unit 203 outputs the examination result information 111 received from the Web-content analysis unit 201. Also, the relevant part output unit 203 outputs the conversion result information 112 received from the Web-content conversion unit 204.

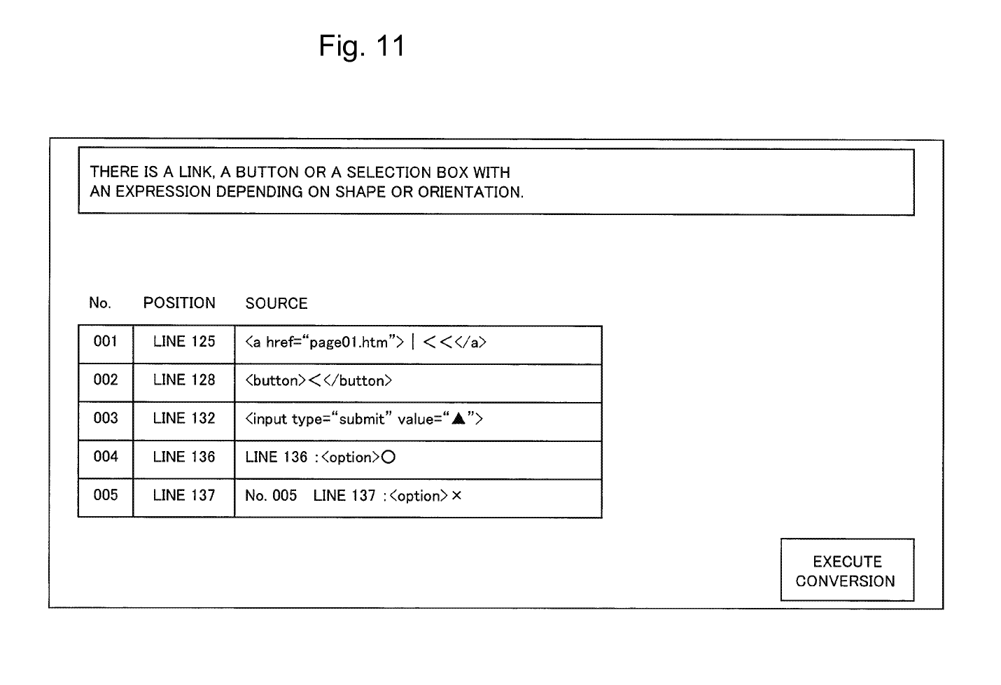

FIG. 11 is a figure showing an example of information including the examination result information 111 which the relevant part output unit 203 outputs. Referring to FIG. 11, the information which the relevant part output unit 203 outputs includes an element including each of the content instruction information 110, an identifier which identifies the element and a number of the line of the code of the Web-content 108. Also, as shown in FIG. 11, the information which the relevant part output unit 203 outputs may include a comment which shows characteristics about each of the content instruction information 110 or the figure-symbol-character.

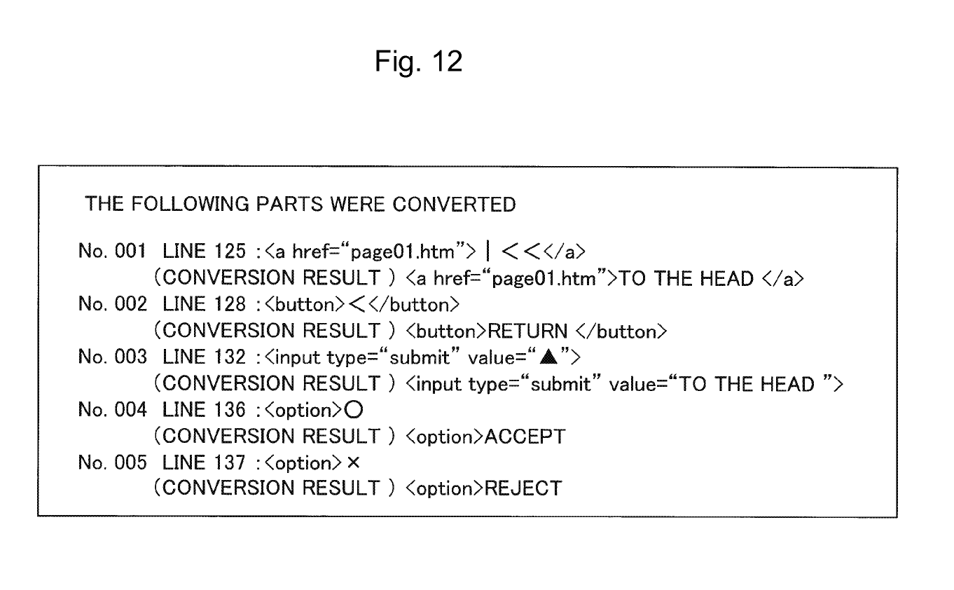

FIG. 12 is a figure showing an example of the information including the conversion result information 112 which the relevant part output unit 203 outputs. Referring to FIG. 12, the information which the relevant part output unit 203 outputs includes an element including each of the content instruction information 110, an identifier which identifies the element and a number of the line of the code of the Web-content 108. Further, the information which the relevant part output unit 203 outputs includes replacement information which is information to which a character string after conversion is added to at least part of the element mentioned above. Also, as shown in FIG. 12, the information which the relevant part output unit 203 outputs may include an arbitrary comment.

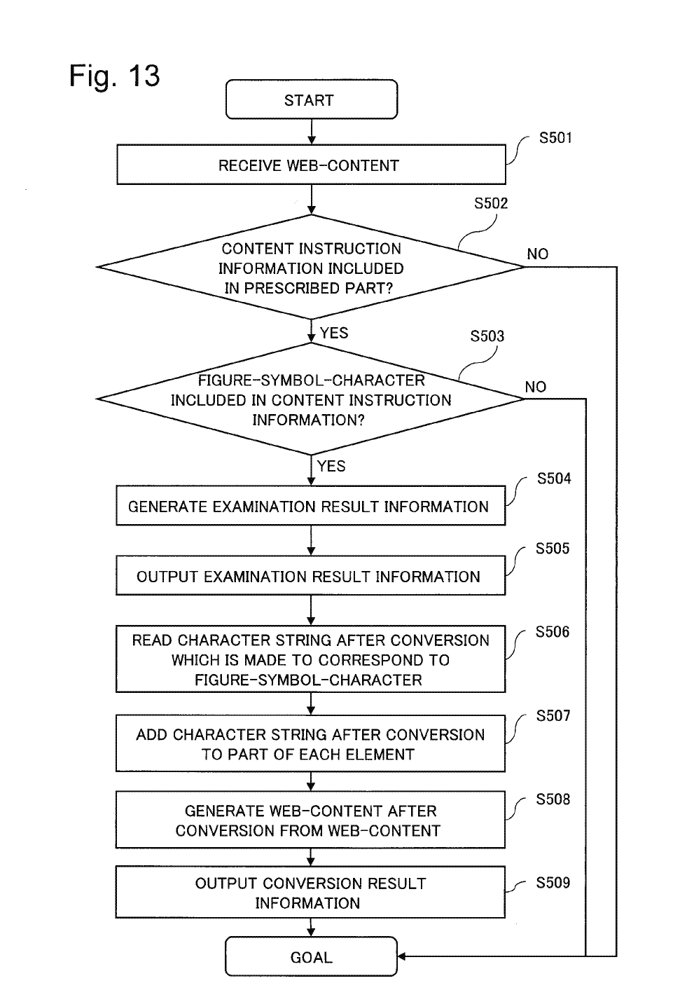

FIG. 13 is a flow chart showing an example of an outline of operation of the Web-content conversion apparatus 200 according to the second exemplary embodiment.

First, the Web-content analysis unit 201 receives the Web-content 108 (Step S501). And the Web-content analysis unit 201 determines presence of the content instruction information 110 which is included in a prescribed part of the received Web-content 108 (Step S502).

When it is determined that the content instruction information 110 is included in the prescribed part of the Web-content 108 (“Yes” in Step S502), the Web-content analysis unit 201 carries out the following processing. That is, the Web-content analysis unit 201 determines whether a figure-symbol-character is included in each of the content instruction information 110 (Step S503). On the other hand, in case the Web-content analysis unit 201 determines that the content instruction information 110 is not included in the prescribed part of the Web-content 108 (“No” in Step S502), the Web-content conversion apparatus 200 ends the processing.

In case it is determined that a figure-symbol-character is included in the content instruction information 110 (“Yes” in Step S503), the Web-content analysis unit 201 generates the examination result information 111 mentioned above (Step S504). And the processing of the Web-content conversion apparatus 200 proceeds to Step S505. On the other hand, in case it is determined that a figure-symbol-character is not included in any of the content instruction information 110 (“No” in Step S503), the Web-content conversion apparatus 200 end the processing.

The relevant part output unit 203 outputs the examination result information 111 which the Web-content analysis unit 201 generated (Step S505).

The Web-content conversion unit 204 receives the Web-content 108 and the examination result information 111 from the Web-content analysis unit 201. And the Web-content conversion unit 204 reads the character string after conversion which is made to correspond to the predetermined figure-symbol-character included in the Web-content 108 from the correspondence relation storage unit 105 respectively based on the received examination result information 111 (Step S506).

And the Web-content conversion unit 204 performs conversion which adds the read character string after conversion to at least part of the element of the Web-content 108 in which the content instruction information 110 is included based on the received examination result information 111 (Step S507).

For each element included in the examination result information 111, the Web-content conversion unit 204 provides the conversion result information 112 which is the information in which the predetermined character string after conversion is made to correspond and added to the relevant part output unit 203.

And the Web-content conversion unit 204 outputs the Web-content after conversion 109 which is generated by converting the Web-content 108 (Step S508).

The relevant part output unit 203 outputs the conversion result information 112 received from the Web-content conversion unit 204 (Step S509).

The Web-content conversion apparatus 200 according to the second exemplary embodiment includes the characteristics which the Web-content conversion apparatus 100 according to the first exemplary embodiment has and has the same effect as the first exemplary embodiment.

Further, the Web-content conversion apparatus 200 according to the second exemplary embodiment outputs the examination result information 111 which is the information which makes the information which can specify a part of the Web-content 108 in which the content instruction information 110 is included and the content instruction information 110 correspond; and includes them. Also, for each element included in the examination result information 111 mentioned above, the Web-content conversion apparatus 200 outputs the conversion result information 112 which is the information which made the corresponding character string after conversion correspond to the figure-symbol-character included in the content instruction information 110 included in the element. Accordingly, an administrator of the Web-content conversion apparatus 200 can recognize a conversion result of the Web-content 108 by this apparatus easily. For example, even when a figure-symbol-character is included in a main text of the Web-content 108 (for example, contents of an element of a <p> markup tag), the administrator can determine whether this figure-symbol-character remains in the Web-content after conversion 109 without being converted. Also, in case a figure-symbol-character is included in the prescribed part of the Web-content 108, the administrator can determine easily whether an appropriate character string after conversion is added to the figure-symbol-character.

Next, a concrete example of operation of the Web-content conversion apparatus 200 according to the second exemplary embodiment of the present invention will be described. In the following concrete example, the Web-content 108 is the content described by the HTML.

First, the Web-content analysis unit 201 receives the Web-content 108 which is an examination target. And the Web-content analysis unit 201 searches for a markup tag included in the Web-content 108 from the head of the content. And the Web-content analysis unit 201 searches for a tag element representing a link, a tag element representing a button and a tag element representing a selection box. The tag element representing a link is, for example, a part of “<a>-</a>”. The tag element representing a button is, for example, a part of “<button>-</button>”, “<input type=‘submit’ value=‘-’>” or “<input type=‘reset’ value=‘-’>”. Also, the tag element representing a selection box is, for example, a part of “<select><option>-</option></select>”.

In case the relevant part mentioned above is detected, the Web-content analysis unit 201 determines, with regard to the tag element representing a link, the tag element representing a button and the tag element representing a selection box, whether a figure-symbol-character stored in the figure-symbol-character storage unit 102 is included. Concretely, the Web-content analysis unit 301 determines whether a figure-symbol-character representing shape or orientation is included in a body part of “<a>-</a>”, “<button>-</button>” and “<select><option>-</option></select>”. As the figure-symbol-character representing shape or orientation, for example, “o”, “”, “x”, “□”, “▪”, “←”, “→”, “↑”, “↓”, “▴”, “▾”, “̂”, “\check{}”, “|<<”, “<”, “>”, “>>|”, “<-”, “->” and so on can be mentioned. These figure-symbol-characters are illustrations at most, and the type of the figure-symbol-characters or their combination, or whether the figure-symbol-character is a two-byte code or a single-byte code, is not limited to these ones.

In case it is determined that there is a relevant figure-symbol-character in the relevant part mentioned above, the Web-content analysis unit 201 accumulates location of the tag element concerned, the tag element concerned and the figure-symbol-character concerned in the Web-content 108 as the examination result information 111.

After examining presence of a figure-symbol-character from the head to the end of the Web-content 108, the Web-content analysis unit 201 provides the examination result information 111 which is accumulated to the relevant part output unit 203. Also, the Web-content analysis unit 201 provides the Web-content 108 to the Web-content conversion unit 204.

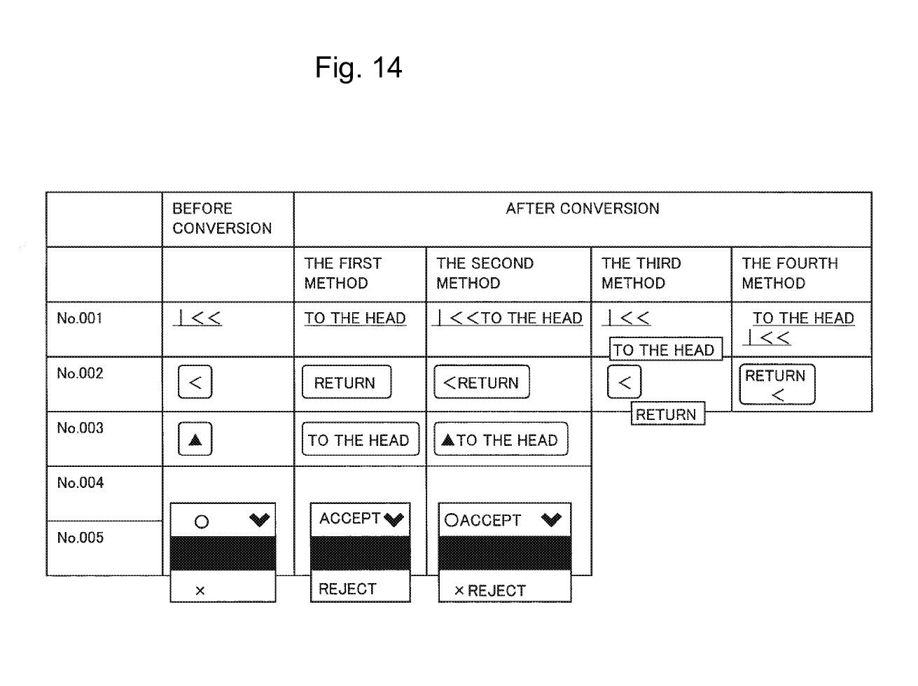

The relevant part output unit 203 outputs the examination result information 111 received from the Web-content analysis unit 201 with the contents illustrated in FIG. 11. Referring to FIG. 11, as a result of the Web-content analysis unit 201 examining the Web-content 108, the Web-content 108 is found to include a character string such as “|<<” in a body part of an a tag at line 125. In other words, on a web browser, a display of this element will be a display of a link name representing orientation which is “|<<”. Similarly, the element of the button tag at line 128 will be a display of a button name which is “<”. The element of the input tag at line 132 will be a display of a button name which is “▴”. Each element at line 136 and line 137 will be a display of which choices in the selection box will be “o” or “x” respectively. FIG. 14 is an example of display when these elements are displayed by the web browser.

Based on the figure-symbol-character included in the examination result information 111, the Web-content conversion unit 204 reads the character string after conversion which is converted from the figure-symbol-character from the correspondence relation storage unit 105. And the Web-content conversion unit 204 rewrites the figure-symbol-character which is included in the element of the Web-content 108 which falls under each element which the received examination result information 111 includes to the character string after conversion read from the correspondence relation storage unit 105. Correspondence between the figure-symbol-character and the character string after conversion here is an example at most, and the type of the figure-symbol-characters or their combination, contents of the character string after conversion, or whether they are in a two-byte code or a single-byte code, is not limited to these ones.

Here, rewriting method of a figure-symbol-character in the Web-content conversion unit 204 will be described. The first conversion method described in the first exemplary embodiment is the method to replace the figure-symbol-character by the character string after conversion. For example, by the Web-content conversion unit 204 converting each element described in No.001-005 from the examination result illustrated in FIG. 3, each element is converted like conversion result of FIG. 5. A display in case these elements are displayed by the web browser will be a display shown in the column of “the first method” in FIG. 14. This conversion method is applied, for example, to the tag element a, the button, the input or the option.

The second conversion method written in the first exemplary embodiment is the method to rewrite to a mode which writes the character string after conversion along with the figure-symbol-character. For example, by the Web-content conversion unit 204 converting each element described in No.001-005 from the examination result illustrated in FIG. 3, each element is converted like conversion result of FIG. 6. A display in case these elements are displayed by the web browser will be a display shown in the column of “the second method” in FIG. 14. This conversion method is applied, for example, to the tag element a, the button, the input or the option.

The third conversion method written in the first exemplary embodiment is the method, by adding the title attribute to the tag element including the figure-symbol-character, to perform conversion which adds the character string after conversion corresponding to the figure-symbol-character as the attribute value. For example, by the Web-content conversion unit 204 converting each element described in No.001 and No.002 from the examination result illustrated in FIG. 3, each element is converted like conversion result of FIG. 7. A display when these elements are displayed by the web browser will be a display shown in the column of “the third method” in FIG. 14. This conversion method is applied, for example, to the tag element a or the button.

The fourth conversion method written in the first exemplary embodiment is the method to perform conversion which writes the figure-symbol-character along with the ruby described by the HTML form. For example, by the Web-content conversion unit 204 converting each element described in No.001 and No.002 from the examination result illustrated in FIG. 3, each element is converted like conversion result of FIG. 8. A display when these elements are displayed by the web browser will be a display shown in the column of “the fourth method” in FIG. 14. This conversion method is applied, for example, to the tag element a or the button.

The Web-content conversion unit 204 performs conversion of each element by at least one of first to the fourth conversion method mentioned above or by combining them. Further, for all the element of the Web-content 108 corresponding to the tag element including each figure-symbol-character included in the examination result information 111 and the figure-symbol-character, the Web-content conversion unit 204 performs conversion of the element concerned. And the Web-content conversion unit 204 outputs the Web-content 108 which is converted as the Web-content after conversion 109. Also, the Web-content conversion unit 204 outputs data which has added processing contents which each element was converted to the contents of the examination result information 111 to the relevant part output unit 203 as the conversion result information 112.

The relevant part output unit 203 outputs the conversion result information 112 received from the Web-content conversion unit 204. The outputted contents correspond to the contents of conversion performed in the Web-content conversion unit 204. In case the Web-content conversion unit 204 converts to the Web-content after conversion 109 by the first conversion method, the relevant part output unit 203 outputs the contents illustrated in FIG. 5. In case the Web-content conversion unit 204 converts to the Web-content after conversion 109 by the second conversion method, the relevant part output unit 203 outputs the contents illustrated in FIG. 6. In case the Web-content conversion unit 204 converts to the Web-content after conversion 109 by the third conversion method, the relevant part output unit 203 outputs the contents illustrated in

FIG. 7. In case the Web-content conversion unit 204 converts to the Web-content after conversion 109 by the fourth conversion method, the relevant part output unit 203 outputs the contents illustrated in FIG. 8.

### The Third Exemplary Embodiment

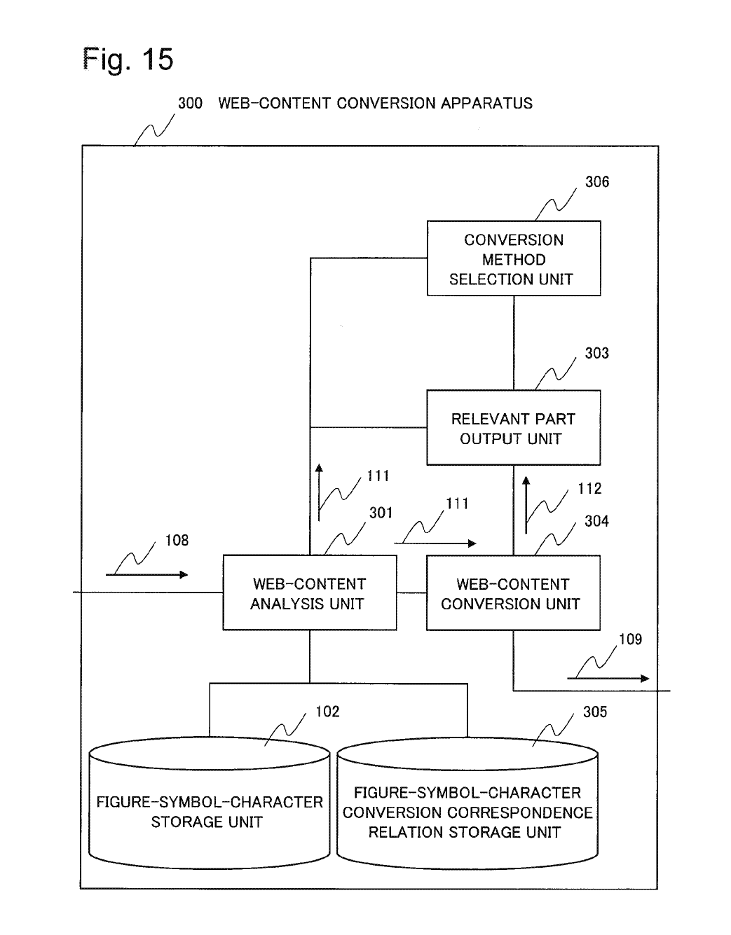

FIG. 15 is a block diagram showing a structure of a Web-content conversion apparatus 300 according to the third exemplary embodiment of the present invention.

Referring to FIG. 15, the Web-content conversion apparatus 300 according to the third exemplary embodiment of the present invention includes a Web-content analysis unit 301, the figure-symbol-character storage unit 102, a relevant part output unit 303, a Web-content conversion unit 304, a correspondence relation storage unit 305 and a conversion method selection unit 306. The Web-content analysis unit 301 is connected with the figure-symbol-character storage unit 102, the relevant part output unit 303, the Web-content conversion unit 304, the correspondence relation storage unit 305 and the conversion method selection unit 306 respectively. The figure-symbol-character storage unit 102 is connected with the Web-content analysis unit 301. The relevant part output unit 303 is connected with the Web-content analysis unit 301, the Web-content conversion unit 304 and the conversion method selection unit 306 respectively. The Web-content conversion unit 304 is connected with the Web-content analysis unit 301 and the relevant part output unit 303 respectively. The correspondence relation storage unit 305 is connected with the Web-content analysis unit 301. The conversion method selection unit 306 is connected with the Web-content analysis unit 301 and the relevant part output unit 303 respectively.

===Figure-Symbol-Character Storage Unit 102===

The figure-symbol-character storage unit 102 is same as the figure-symbol-character storage unit 102 according to the first exemplary embodiment.

===Correspondence Relation Storage Unit 305===

The correspondence relation storage unit 305 links and stores a figure-symbol-character and a conversion candidate group which includes at least one character string after conversion which is a character string representing the meaning of the figure-symbol-character.

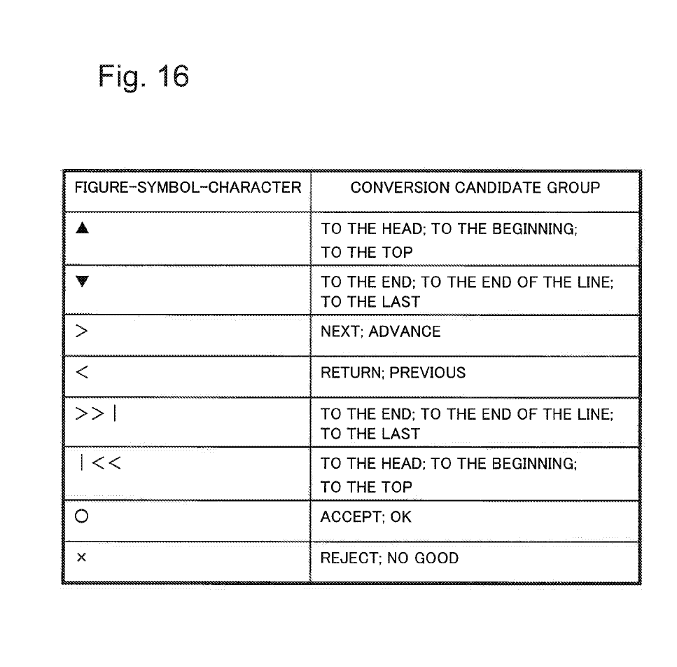

FIG. 16 is an example which shows information stored in the correspondence relation storage unit 305.

Referring to FIG. 16, for example, the correspondence relation storage unit 305 links and stores the figure-symbol-character “▴” and the conversion candidate group including the character string after conversion “to the head”, “to the beginning” and “to the top”.

===Web-Content Analysis Unit 301===

First, the Web-content analysis unit 301 stores rule selection information 113 which is information which made a class of a markup tag and a rule identifier which identifies a method to convert the Web-content 108 correspond.

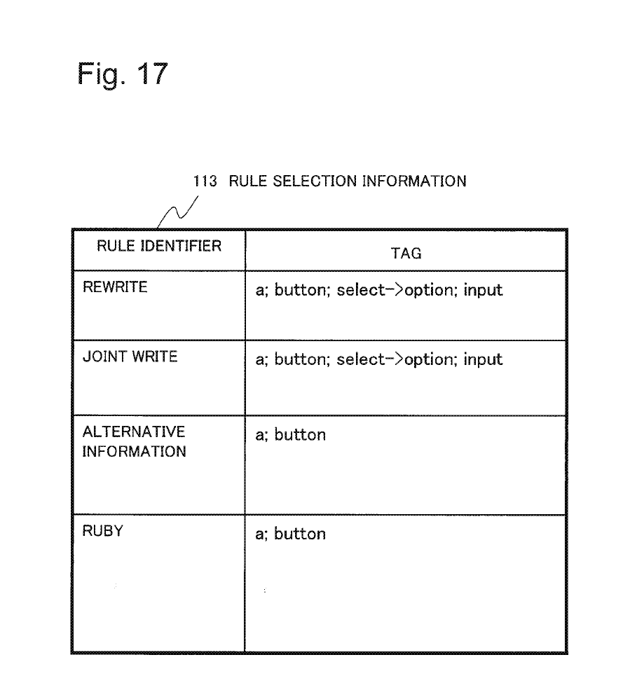

FIG. 17 is a figure showing an example of the rule selection information 113 which the Web-content analysis unit 301 stores. Referring to FIG. 17, the Web-content analysis unit 301 includes as the rule identifier, for example, “rewrite”. Also, the Web-content analysis unit 301 links and stores the information which shows the class of the markup tag with the rule identifier. For example, the Web-content analysis unit 301 links and stores the information which identifies the class of the markup tag “a; button; select->option; input” with the rule identifier “rewrite”. The information which identifies the class of the markup tag “a; button; select->option; input” means the following. That is, the information mentioned above means that the conversion method identified by the rule identifier is applied within a scope of “the markup tag a, the markup tag button, the markup tag option which the markup tag select includes, and the markup tag input”.

Second, the Web-content analysis unit 301 determines presence of the content instruction information 110 which is included in a prescribed part of the received Web-content 108. This operation is same as the operation of the Web-content analysis unit 101 according to the first exemplary embodiment.

Third, in case it is determined that the content instruction information 110 is included in the prescribed part of the Web-content 108, the Web-content analysis unit 301 determines whether a figure-symbol-character is included in each of the content instruction information 110. In this case, the Web-content analysis unit 301 determines whether a figure-symbol-character stored in the figure-symbol-character storage unit 102 corresponds to each character included in each of the content instruction information 110.

Fourth, whenever it is determined that there is a figure-symbol-character in the content instruction information 110 in the prescribed part of the Web-content 108, the Web-content analysis unit 301 carries out the following processing. That is, the Web-content analysis unit 301 links the content instruction information 110 and the information which shows the prescribed part mentioned above, and stores them as the examination result information 111. This examination result information 111 is same as the examination result information 111 according to the first exemplary embodiment.

Fifth, whenever it is determined that there is a figure-symbol-character in the content instruction information 110 in the prescribed part of the Web-content 108, the Web-content analysis unit 301 specifies the class of the markup tag which the element including the content instruction information 110 includes. And the Web-content analysis unit 301 specifies the rule identifier which is made to correspond to the class of the specified markup tag based on the rule selection information 113 mentioned above.

Sixth, for each figure-symbol-character which is included in the content instruction information 110 included in each element included in the examination result information 111, the Web-content analysis unit 301 reads the conversion candidate group which is made to correspond to the figure-symbol-character from the correspondence relation storage unit 305.

Seventh, for each figure-symbol-character which is included in the content instruction information 110 included in each element included in the examination result information 111, the Web-content analysis unit 301 links the conversion candidate group and the rule identifier which is specified based on the class of the markup tag which the element includes. And the Web-content analysis unit 301 provides the conversion candidate group and the rule identifier which are made to correspond and the examination result information 111 to the relevant part output unit 303.

Eighth, the Web-content analysis unit 301 receives from the conversion method selection unit 306 the examination result information 111, the rule identifier and the character string after conversion which are made to correspond for each element which the examination result information 111 includes. And the Web-content analysis unit 301 provides each received information and the Web-content 108 to the Web-content conversion unit 304.

===Relevant Part Output Unit 303===

The relevant part output unit 303 makes the rule identifier and the conversion candidate group, which are made to correspond respectively to each element which is included in the examination result information 111 in which the Web-content analysis unit 301 made the rule identifier and the conversion candidate group correspond, correspond to each of the corresponding element respectively, and outputs them. Also, the relevant part output unit 303 outputs the conversion result information 112 received from the Web-content conversion unit 304 same as the relevant part output unit 203 according to the second exemplary embodiment.

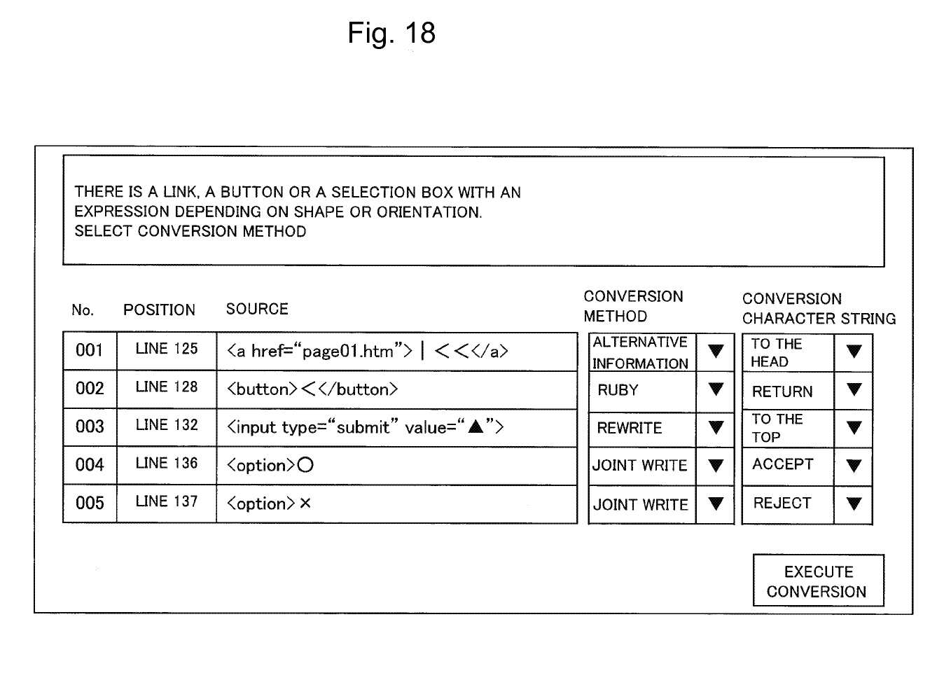

FIG. 18 is a figure showing an example of information which the relevant part output unit 303 outputs. Referring to FIG. 18, the information which the relevant part output unit 303 outputs includes an element including each of the content instruction information 110, an identifier of the element and a number of the line of the code of the Web-content 108. Also, as shown in FIG. 18, the information which the relevant part output unit 303 outputs includes a conversion candidate group and a rule identifier corresponding to each element. Referring to FIG. 18, the information outputted in the field of “conversion method” is the rule identifier. This field is made, for example, a drop down list, and a user of the Web-content conversion apparatus 300 can select several rule identifiers 311 from the list. Also, referring to FIG. 18, the information outputted in the field of “conversion character string” is the conversion candidate group. This field is made, for example, a drop down list, and the user of the Web-content conversion apparatus 300 can select several character strings after conversion included in the conversion candidate group from the list.

The drop down list mentioned above is an example of a means which the relevant part output unit 303 outputs the information. The method which the relevant part output unit 303 outputs the rule identifier or the conversion candidate group is not limited to the method mentioned above. For example, the method which outputs the rule identifier or the conversion candidate group may be a method using combo box which can input an arbitrary character string.

===Conversion Method Selection Unit 306===

When the information which specifies the rule identifier to be selected and the information which specifies the character string after conversion are received for each element, the conversion method selection unit 306 links the rule identifier and the character string after conversion specified by each information respectively to the element corresponding to each. And the conversion method selection unit 306 provides the examination result information 111 including each element, the rule identifier and the character string after conversion mentioned above to the Web-content analysis unit 301.

===Web-Content Conversion Unit 304===

The Web-content conversion unit 304 receives from the Web-content analysis unit 301 the Web-content 108, the examination result information 111, and the rule identifier and the character string after conversion mentioned above which are made to correspond to each element included in the examination result information 111. And for each element included in the examination result information 111, the Web-content conversion unit 304 performs conversion from the Web-content 108 to the Web-content after conversion 109 based on the rule identifier which is made to correspond to the element. For example, in case the rule identifier is the information such as “alternative information”, the Web-content conversion unit 304 performs conversion, for example, using the third conversion method of the Web-content conversion unit 104 according to the first exemplary embodiment, from the Web-content 108 to the Web-content after conversion 109. In this case, the Web-content conversion unit 304 generates the replacement information mentioned above. This replacement information is the information which added the character string after conversion which is made to correspond to the element to at least part of the element. And by performing conversion which replaces the element by the replacement information mentioned above, the Web-content conversion unit 304 converts the Web-content 108 to the Web-content after conversion 109.

For each element including the content instruction information 110 included in the examination result information 111, the Web-content conversion unit 304 provides the conversion result information 112 which is the information to which the replacement information mentioned above was made to correspond respectively to the relevant part output unit 303. And the Web-content conversion unit 304 outputs the Web-content after conversion 109 which is generated by converting the Web-content 108 to outside.

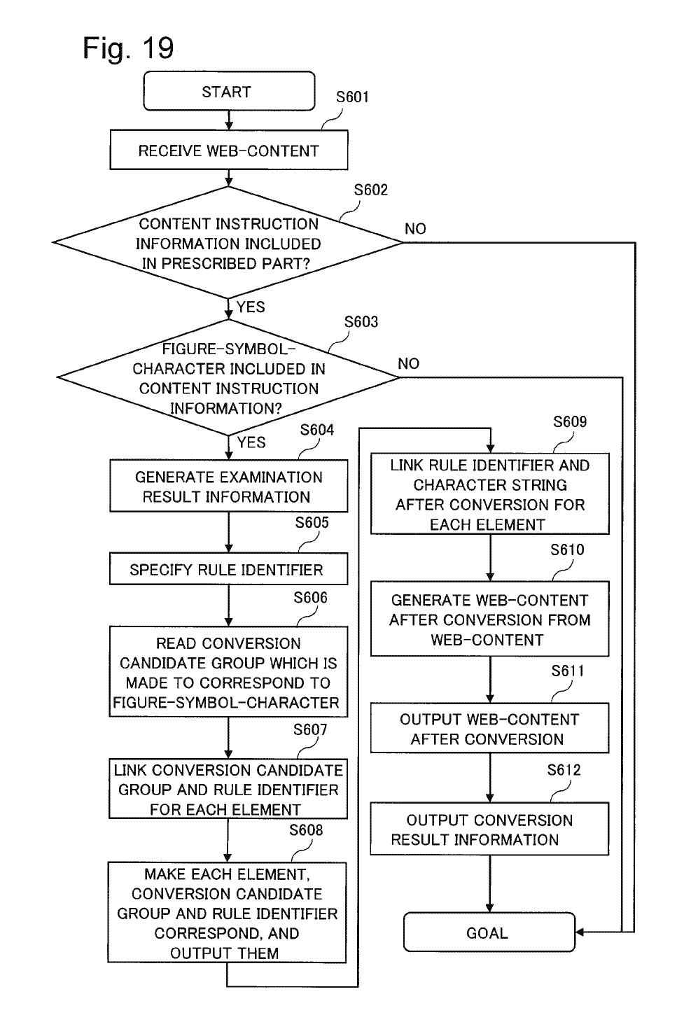

FIG. 19 is a flow chart showing an example of an outline of operation of the Web-content conversion apparatus 300 according to the third exemplary embodiment.

First, the Web-content analysis unit 301 receives the Web-content 108 (Step S601). And the Web-content analysis unit 301 determines presence of the content instruction information 110 which is included in a prescribed part of the received Web-content 108 (Step S602).

In case it is determined that the content instruction information 110 is included in the prescribed part of the Web-content 108 (“Yes” in Step S602), the Web-content analysis unit 301 carries out the following processing. That is, the Web-content analysis unit 301 determines whether a figure-symbol-character is included in each of the content instruction information 110 (Step S603). On the other hand, in case the Web-content analysis unit 301 determines that the content instruction information 110 is not included in the prescribed part of the Web-content 108 (“No” in Step S602), the Web-content conversion apparatus 300 ends the processing.

In case it is determined that a figure-symbol-character is included in the content instruction information 110 (“Yes” in Step S603), the Web-content analysis unit 301 generates the examination result information 111 mentioned above (Step S604). And the processing of the Web-content conversion apparatus 300 proceeds to Step S605. On the other hand, in case it is determined that a figure-symbol-character is not included in any of the content instruction information 110 (“No” in Step S603), the Web-content conversion apparatus 300 ends the processing.

Whenever it is determined that there is a figure-symbol-character in the content instruction information 110 in the prescribed part of the Web-content 108, the Web-content analysis unit 301 specifies the class of the markup tag which the element including the content instruction information 110 includes. And the Web-content analysis unit 301 specifies the rule identifier which is made to correspond to the class of the specified markup tag based on the rule selection information 113 mentioned above (Step S605).

For each figure-symbol-character which is included in the content instruction information 110 included in each element included in the examination result information 111 mentioned above, the Web-content analysis unit 301 carries out the following processing. That is, the Web-content analysis unit 301 reads the conversion candidate group which is made to correspond to the figure-symbol-character from the correspondence relation storage unit 305 (Step S606). And the Web-content analysis unit 301 provides the Web-content 108 to the Web-content conversion unit 304.

For each figure-symbol-character which is included in the content instruction information 110 included in each element included in the examination result information 111, the Web-content analysis unit 301 links the conversion candidate group and the rule identifier mentioned above which is specified based on the class of the markup tag which the element includes (Step S607). And the Web-content analysis unit 301 provides the conversion candidate group and the rule identifier which are made to correspond and the examination result information 111 to the relevant part output unit 303.

The relevant part output unit 303 links and outputs the rule identifier and the conversion candidate group, which are made to correspond respectively to each element which is included in the examination result information 111 in which the Web-content analysis unit 301 made the rule identifier and the conversion candidate group correspond, to each of the corresponding element respectively (Step S608).

When the information which specifies the rule identifier to be selected and the information which specifies the character string after conversion are received for each element, the conversion method selection unit 306 links the rule identifier and the character string after conversion specified by each information respectively to the element corresponding to each (Step S609). And the conversion method selection unit 306 provides the examination result information 111 including each element, the rule identifier and the character string after conversion mentioned above to the Web-content analysis unit 301. The Web-content analysis unit 301 provides the received Web-content 108, the examination result information 111, the rule identifier and the character string after conversion to the Web-content conversion unit 304.

The Web-content conversion unit 304 receives from the Web-content analysis unit 301 the Web-content 108, the examination result information 111, and the rule identifier and the character string after conversion mentioned above which are made to correspond to each element included in the examination result information 111. And for each element of the Web-content 108 corresponding to the element included in the examination result information 111, the Web-content conversion unit 304 performs conversion from the Web-content 108 to the Web-content after conversion 109 based on the rule identifier and the character string after conversion which are made to correspond to the element (Step S610).

And the Web-content conversion unit 304 outputs the Web-content after conversion 109 which is generated by converting the Web-content 108 (Step S611).

The relevant part output unit 303 outputs the conversion result information 112 received from the Web-content conversion unit 304 (Step S612).

The Web-content conversion apparatus 300 according to the third exemplary embodiment includes the characteristics which the Web-content conversion apparatus 100 according to the first exemplary embodiment and the Web-content conversion apparatus 200 according to the second exemplary embodiment have. Accordingly, the Web-content conversion apparatus 300 according to the third exemplary embodiment has the same effect as the first exemplary embodiment or the second exemplary embodiment.

Further, the Web-content conversion apparatus 300 according to the third exemplary embodiment receives the information which can specify the rule identifier which identifies the method to convert the Web-content for each element included in the examination result information 111. And by replacing the corresponding element by the replacement information using the conversion method which is specified based on the received information, the Web-content conversion apparatus 300 converts the Web-content 108 to the Web-content after conversion 109. Accordingly, the Web-content conversion apparatus 300 according to the third exemplary embodiment can convert the Web-content 108 using the conversion method different for each element included in the Web-content 108. For example, referring to FIG. 18, the element ‘<a href=“page01.htm”>|<<</a>’ at line 125 of the Web-content 108 is converted by the conversion method “alternative information”. On the other hand, the element ‘<button><</button>’ at line 125 of the Web-content 108 is converted by the conversion method “ruby”. As above, the Web-content conversion apparatus 300 according to the third exemplary embodiment can convert each element including a figure-symbol-character by using the different conversion method for each element which the Web-content 108 includes.

Also, the Web-content conversion apparatus 300 according to the third exemplary embodiment may, depending on a markup tag, not be able to perform a predetermined conversion due to the specification of the markup tag. In this case, the Web-content conversion apparatus 300 can set the rule identifier which is provided to the relevant part output unit 303 as the rule selection information 113 for each class of the markup tag. Therefore, the Web-content conversion apparatus 300 can make a user not to select the rule identifier which identifies the predetermined conversion which cannot be performed due to the specification of the markup tag.

For each element included in the examination result information 111, the Web-content conversion apparatus 300 according to the third exemplary embodiment receives information which can specify the character string after conversion representing the meaning of the figure-symbol-character which the element includes. And the Web-content conversion apparatus 300 replaces the element by the replacement information which is the information which added the character string after conversion specified by the received information to at least part of the corresponding element. Accordingly, the Web-content conversion apparatus 300 according to the third exemplary embodiment can, by using the different character string after conversion for each element included in Web-content, perform conversion of the Web-content 108. A figure-symbol-character may not have a single meaning necessarily. Therefore, by making the user select an appropriate character string after conversion for each element, the Web-content conversion apparatus 300 according to the third exemplary embodiment can perform more appropriate conversion of the Web-content 108.

Next, a concrete example of operation of the Web-content conversion apparatus 300 according to the third exemplary embodiment of the present invention will be described. In the following concrete example, the Web-content 108 is the content described by the HTML.

First, the Web-content analysis unit 301 receives the Web-content 108 which is an examination target. And the Web-content analysis unit 301 searches for a markup tag included in the Web-content 108 from the head of the content. And the Web-content analysis unit 301 searches for a tag element representing a link, a tag element representing a button and a tag element representing a selection box. For example, the tag element representing a link is a part of “<a>-</a>”. The tag element representing a button is, for example, a part of “<button>-</button>”, “<input type=‘submit’ value=‘-’>” or “<input type=‘reset’ value=‘-’>”. Also, the tag element representing a selection box is, for example, a part of “<select><option>-</option></select>”.

In case the relevant part mentioned above is detected, the Web-content analysis unit 301 determines, with regard to the tag element representing a link, the tag element representing a button and the tag element representing a selection box, whether a figure-symbol-character stored in the figure-symbol-character storage unit 102 is included. Concretely, the Web-content analysis unit 301 determines whether a figure-symbol-character representing shape or orientation is included in a body part of “<a>-</a>”, “<button>-</button>” and “<select><option>-</option></select>”. As the figure-symbol-character representing shape or orientation, for example, “o”, “”, “x”, “□”, “▪”, “←”, “→”, “↑”, “↓”, “▴”, “▾”, “̂”, “\check{}”, “|<<”, “<”, “>”, “>>|”, “<-”, “->” and so on can be mentioned. These figure-symbol-characters are illustrations at most, and the type of the figure-symbol-characters or their combination, or whether the figure-symbol-character is a two-byte code or a single-byte code, is not limited to these ones.

In case it is determined that there is a relevant figure-symbol-character in the relevant part mentioned above, the Web-content analysis unit 301 accumulates location of the tag element concerned in the Web-content 108, the tag element concerned and the figure-symbol-character concerned as the examination result information 111.

After examining presence of a figure-symbol-character from the head to the end of the Web-content 108, the Web-content analysis unit 301 reads, for each figure-symbol-character which is included in the accumulated examination result information 111, the conversion candidate group which is made to correspond to the figure-symbol-character from the correspondence relation storage unit 305. Also, for each tag element included in the examination result information 111 mentioned above, the Web-content analysis unit 301 specifies the class of the tag which the tag element includes. Further, the Web-content analysis unit 301 specifies the rule identifier which is made to correspond to the class of the specified tag, and which identifies the conversion method of the Web-content. Further, the rule identifier is the information which identifies either of the first conversion method to the fourth conversion method described in the first exemplary embodiment. The rule identifier “rewrite” is the rule identifier which identifies the first conversion method. The rule identifier “joint write” is the rule identifier which identifies the second conversion method. The rule identifier “alternative information” is the rule identifier which identifies the third conversion method. The rule identifier “ruby” is the rule identifier which identifies the fourth conversion method.

And for each tag element included in the examination result information 111 mentioned above, the Web-content analysis unit 301 links the information including the conversion candidate group read respectively and the rule identifier specified respectively to the tag element as conversion method candidate information. The Web-content analysis unit 301 provides the examination result information and the conversion method candidate information which is made to correspond for each tag element which the examination result information includes to the relevant part output unit 303. The relevant part output unit 303 outputs the received examination result information and the conversion method candidate information.

For example, referring to FIG. 18, the tag element described in No.002 includes a button tag, and this tag element includes a figure-symbol-character “<”. Also, referring to FIG. 17, the Web-content analysis unit 301 links and stores the button tag to “rewrite”, “joint write”, “alternative information” and “ruby”. Also, referring to FIG. 16, the correspondence relation storage unit 305 stores, by linking to the figure-symbol-character “<”, the conversion candidate group “return; previous”. Accordingly, the conversion method candidate information which is made to correspond to the tag element of No.002 of FIG. 18 includes “rewrite”, “joint write”, “alternative information” and “ruby” as the rule identifier. Also, the conversion method candidate information concerned includes “return; previous” as the conversion candidate group.

Also, referring to FIGS. 16, 17 and 18, the tag element described in No.003 includes an input tag. Therefore, same as the description of the tag element of No.002, the conversion method candidate information includes “rewrite” and “joint write” as the rule identifier. Also, the conversion method candidate information concerned includes “to the head; to the beginning; to the top” as the conversion candidate group.

For each tag element which is included in the examination result information 111 which the relevant part output unit 303 outputs, the conversion method selection unit 306 receives the information which specifies either of the rule identifiers and the information which specifies either of the character strings after conversion included in the conversion candidate group. And for each tag element mentioned above, the conversion method selection unit 306 generates conversion method decision information which is the information which the rule identifier and the character string after conversion specified by each information mentioned above are made to correspond. And the conversion method selection unit 306 provides the conversion method decision information to the Web-content analysis unit 301.

Referring to FIG. 18, to the element described in No.002, the rule identifier “ruby” and the character string after conversion “return” are linked.

The Web-content analysis unit 301 provides the Web-content 108 which is the examination target and the conversion method decision information received from the conversion method selection unit 306 to The Web-content conversion unit 304.

The Web-content conversion unit 304 receives the Web-content 108 and the conversion method decision information from the Web-content analysis unit 301. And for each element of the Web-content 108 corresponding to the tag element included in the conversion method decision information respectively, and by the conversion method which is identified by the rule identifier which is made to correspond to the tag element, the Web-content conversion unit 304 converts the tag element. The Web-content conversion unit 304 performs this conversion respectively for all tag elements included in the conversion method decision information.

For example, for the element described in No.001, conversion in which the character string which says “to the head” is added as the alternative information of the figure-symbol-character is performed. Likewise, for the element described in No.002, conversion in which the character string which says “return” is added as the ruby of the figure-symbol-character is performed. For the element described in No.003, conversion in which the figure-symbol-character is replaced by the character string which says “to the top” is performed. For the elements described in No.004 and No.005, conversion in which the character strings which say “accept” and “reject” are added after the figure-symbol-characters respectively is performed.

The Web-content conversion unit 304 outputs the Web-content after conversion 109 for which the conversion of each element which the Web-content 108 corresponding to each tag element included in the conversion method decision information includes has completed. And the Web-content conversion unit 304 provides the conversion result information 112 to the relevant part output unit 303. The conversion result information 112 is the information in which, for each tag element included in the conversion method decision information, either of the character strings after conversion which are included in the conversion candidate group read from the correspondence relation storage unit 305 based on the figure-symbol-character included in the tag element are made to correspond.

The relevant part output unit 303 outputs the conversion result information 112 received from the Web-content conversion unit 304. The relevant part output unit 303 outputs information including the conversion result information 112, for example, as shown in FIG. 5.

Further, each exemplary embodiment described above is a preferred exemplary embodiment of the present invention, and the scope of the present invention is not limited to only the exemplary embodiment mentioned above. For each exemplary embodiment, embodiments for which various changes are performed within the range that does not deviate from the scope of this invention are possible.

Also, for each component in each exemplary embodiment of the present invention, its function can be realized not only by hardware but also using a computer and a program. The program is recorded in a computer-readable recording medium such as a magnetic disk and a semiconductor memory, and provided. And the program is read at a time when the computer is started and so on. By controlling the operation of the computer, this read program makes the computer function as the component in each exemplary embodiment mentioned above.

One of the effects of the present invention is to be able to convert an expression of an instruction provided for understanding and operating Web-content to an expression which shows the meaning corresponding to the Web-content appropriately.

This application claims priority based on Japanese Patent Application No. 2010-090522 filed on Apr. 9, 2010 and the disclosure thereof is incorporated herein in its entirety.

Although a part or all of the exemplary embodiment mentioned above can also be described like the following supplementary notes, but are not limited to the following.

(Supplementary Note 1)

A Web-content conversion apparatus including: a figure-symbol-character conversion correspondence relation storage unit which links and stores a figure-symbol-character which is a symbol-character representing a figure and a character string after conversion which is a character string representing the meaning of the figure-symbol-character concerned;

a Web-content analysis unit which, among elements which are included in an inputted Web-content, and in case a figure-symbol-character is included in content instruction information which shows contents of the element including a predetermined markup tag or an attribute value of an attribute which the predetermined markup tag includes, reads the character string after conversion which is made to correspond to the figure-symbol-character concerned from the figure-symbol-character conversion correspondence relation storage unit; and

a Web-content conversion unit which, for each element included in the Web-content and including content instruction information including a figure-symbol-character, by using replacement information which is information which added the character string after conversion which the Web-content analysis unit read based on the figure-symbol-character which is included in the content instruction information included in the element to at least part of the element, and by replacing the element concerned, converts the Web-content to Web-content after conversion.

(Supplementary Note 2)

The Web-content conversion apparatus which is the Web-content conversion apparatus described in the supplementary note 1, wherein

the Web-content analysis unit including:

storing rule selection information which is information which made a class of a markup tag and a rule identifier which identifies a method to convert the Web-content correspond,

specifying, for each element including the content instruction information which is included in the Web-content inputted, the class of the markup tag which the element includes,

specifying respectively the rule identifier which is made to correspond to the class specified based on the rule selection information,

generating examination result information including information in which location information which is information which specifies a location in the Web-content of the element including the content instruction information including a figure-symbol-character and the element concerned are made to correspond, and

linking, for each element which is included in the examination result information generated, one or more of the rule identifiers specified corresponding to the class of the markup tag which the element includes to the element concerned, and

the Web-content conversion unit including: for each element of the Web-content corresponding to the element included in the examination result information to which the Web-content analysis unit made the rule identifier correspond, and based on the rule identifier which is made to correspond to the element, specifying the replacement information of the element concerned.

(Supplementary Note 3)

The Web-content conversion apparatus which is the Web-content conversion apparatus described in the supplementary note 2, wherein the Web-content conversion apparatus including:

a relevant part output unit which links and outputs the rule identifier, which is made to correspond respectively to each element included in the examination result information to which the Web-content analysis unit made the rule identifier correspond, to each of the element respectively; and

a conversion method selection unit which, for each element included in the examination result information, receives an identifier selection result which is information which shows either of the rule identifier which is made to correspond to the element and links the rule identifier which is shown by the received identifier selection result to the element concerned; and

the Web-content conversion unit including: for each element of the Web-content corresponding to the element included in the examination result information to which the conversion method selection unit made the rule identifier correspond, and based on the rule identifier which is made to correspond to the element, specifying the replacement information of the element concerned.

(Supplementary Note 4)

The Web-content conversion apparatus which is the Web-content conversion apparatus described in either of the supplementary note 1 to 3, wherein

the figure-symbol-character conversion correspondence relation storage unit links and stores the figure-symbol-character and a conversion candidate group which includes a plurality of character strings after conversion of the figure-symbol-character,

the Web-content analysis unit, in case a figure-symbol-character is included in the content instruction information, reads the conversion candidate group which is made to correspond to the figure-symbol-character from the figure-symbol-character conversion correspondence relation storage unit, and

the Web-content conversion unit, for each element included in the Web-content and including the content instruction information including the figure-symbol-character, by using the replacement information which is the information which added at least one character string after conversion which is included in the conversion candidate group which the Web-content analysis unit read based on the figure-symbol-character which is included in the content instruction information included in the element to at least part of the element concerned, and by replacing the element concerned, converts the Web-content to the Web-content after conversion.

(Supplementary Note 5)

The Web-content conversion apparatus which is the Web-content conversion apparatus described in the supplementary note 3, wherein

the figure-symbol-character conversion correspondence relation storage unit links and stores the figure-symbol-character and the conversion candidate group which includes a plurality of character strings after conversion of the figure-symbol-character,

the Web-content analysis unit, in case a figure-symbol-character is included in the content instruction information, reads the conversion candidate group which is made to correspond to the figure-symbol-character from the figure-symbol-character conversion correspondence relation storage unit,

the Web-content analysis unit, for each element which is included in the examination result information generated, links the rule identifier specified corresponding to the class of the markup tag which the element includes and the conversion candidate group which is read based on the figure-symbol-character which is included in the content instruction information included in the element concerned to the element concerned respectively,

the relevant part output unit, for each element which is included in the examination result information in which the Web-content analysis unit made the rule identifier and the conversion candidate group correspond, links and outputs respectively the rule identifier and the conversion candidate group which are made to correspond to the element to the element concerned,

the conversion method selection unit, for each element included in the examination result information,

receives a character string selection result which is information which shows either of the character string after conversion which is included in the conversion candidate group which is made to correspond to the element concerned together with the identifier selection result respectively, and links the rule identifier which is shown by the identifier selection result corresponding to the element concerned and the character string after conversion shown by the character string selection result corresponding to the element concerned to the element concerned respectively, and

the Web-content conversion unit, for each element which the Web-content corresponding to the element which is included in the examination result information in which the conversion method selection unit made the rule identifier and the character string after conversion correspond includes, and based on the rule identifier which is made to correspond to the element, by specifying the replacement information which is the information which added at least one character string after conversion which is included in the conversion candidate group which the Web-content analysis unit read based on the figure-symbol-character which is included in the content instruction information included in the element concerned to at least part of the element concerned, and by replacing the element concerned using the replacement information concerned, converts the Web-content to the Web-content after conversion.

(Supplementary Note 6)

The Web-content conversion apparatus which is the Web-content conversion apparatus described in either of the supplementary note 1 to 5, wherein

the replacement information is the information which, among the elements, replaced the figure-symbol-character which is included in the content instruction information included in the element concerned by the character string after conversion which the Web-content analysis unit read based on the figure-symbol-character concerned.

(Supplementary Note 7)

The Web-content conversion apparatus which is the Web-content conversion apparatus described in either of the supplementary note 1 to 6, wherein

the replacement information is the information which, among the elements, added to the figure-symbol-character which is included in the content instruction information included in the element concerned the character string after conversion which the Web-content analysis unit read based on the figure-symbol-character concerned.

(Supplementary Note 8)

The Web-content conversion apparatus which is the Web-content conversion apparatus described in either of the supplementary note 1 to 7, wherein

the replacement information is the information which, as an attribute value of an attribute for adding supplementary information to the element, set the character string after conversion which the Web-content analysis unit read based on the figure-symbol-character which is included in the content instruction information which the element concerned includes to the element concerned.

(Supplementary Note 9)

The Web-content conversion apparatus which is the Web-content conversion apparatus described in either of the supplementary note 1 to 8, wherein

the replacement information is the information which, among the elements, added to the figure-symbol-character which is included in the content instruction information included in the element concerned the character string after conversion which the Web-content analysis unit read based on the figure-symbol-character concerned as the information used for displaying it as a ruby of the figure-symbol-character concerned.

(Supplementary Note 10)

A Web-content conversion method comprising: linking and storing in a storage unit a figure-symbol-character which is a symbol-character representing a figure and a character string after conversion which is a character string representing the meaning of the figure-symbol-character concerned;

among elements which are included in an inputted Web-content, and in case a figure-symbol-character is included in content instruction information which shows contents of the element including a predetermined markup tag or an attribute value of an attribute which the predetermined markup tag includes, reading the character string after conversion which is made to correspond to the figure-symbol-character concerned from the storage unit; and

for each element included in the Web-content and including the content instruction information including a figure-symbol-character, by using replacement information which is information which added the character string after conversion read based on the figure-symbol-character which is included in the content instruction information included in the element to at least part of the element, and by replacing the element concerned, converting the Web-content to Web-content after conversion.

(Supplementary Note 11)

The Web-content conversion apparatus which is the Web-content conversion apparatus described in the supplementary note 1, including:

a voice read aloud unit which outputs the Web-content after conversion by voice, wherein

the voice read aloud unit outputs information which the character string after conversion shows by voice.

(Supplementary Note 12)

A Web-content conversion program which makes a computer carry out processing comprising:

processing which links and stores in a storage unit a figure-symbol-character which is a symbol-character representing a figure and a character string after conversion which is a character string representing the meaning of the figure-symbol-character concerned;

processing which, among elements which are included in an inputted Web-content, and in case a figure-symbol-character is included in content instruction information which shows contents of the element including a predetermined markup tag or an attribute value of an attribute which the predetermined markup tag includes, reads the character string after conversion which is made to correspond to the figure-symbol-character concerned from the storage unit; and

processing which, for each element included in the Web-content and including the content instruction information including a figure-symbol-character, by using replacement information which is information which added the character string after conversion read based on the figure-symbol-character which is included in the content instruction information included in the element to at least part of the element, and by replacing the element concerned, converts the Web-content to Web-content after conversion.

### INDUSTRIAL APPLICABILITY

The Web-content conversion apparatus in each exemplary embodiment of the present invention can be applied for use which converts Web-content. For example, the Web-content conversion apparatus extracts a symbol-character which expresses a figure which cannot be read aloud correctly by a voice read aloud means from the Web-content and replaces the symbol-character by a character string which satisfies the accessibility considering aged people or people with disabilities. By this processing, the Web-content conversion apparatus can perform conversion to the Web-content after conversion which satisfies the accessibility mentioned above.

### DESCRIPTION OF CODE

100, 200, 300 Web-content conversion apparatus
101, 201, 301 Web-content analysis unit
102 Figure-symbol-character storage unit
203, 303 Relevant part output unit
104, 204, 304 Web-content conversion unit
105, 305 Figure-symbol-character conversion correspondence relation storage unit (correspondence relation storage unit)
306 Conversion method selection unit
108 Web-content
109 Web-content after conversion
110 Content instruction information
111 Examination result information
112 Conversion result information
113 Rule selection information

1. A Web-content conversion apparatus comprising:
a figure-symbol-character conversion correspondence relation storage unit which links and stores a figure-symbol-character which is a symbol-character representing a figure and a character string after conversion which is a character string representing the meaning of the figure-symbol-character concerned;
a Web-content analysis unit which, among elements which are included in an inputted Web-content, and in case a figure-symbol-character is included in content instruction information which shows contents of the element including a predetermined markup tag or an attribute value of an attribute which the predetermined markup tag includes, reads the character string after conversion which is made to correspond to the figure-symbol-character concerned from the figure-symbol-character conversion correspondence relation storage unit; and
a Web-content conversion unit which, for each element included in the Web-content and including the content instruction information including a figure-symbol-character, by using replacement information which is information which added the character string after conversion which the Web-content analysis unit read based on the figure-symbol-character which is included in the content instruction information included in the element to at least part of the element, and by replacing the element concerned, converts the Web-content to Web-content after conversion, wherein
the Web-content analysis unit includes:
storing rule selection information which is information which made a class of a markup tag and a rule identifier which identifies a method to convert the Web-content correspond,
specifying, for each element including the content instruction information which is included in the Web-content inputted, the class of the markup tag which the element includes,
specifying respectively the rule identifier which is made to correspond to the class specified based on the rule selection information,
generating examination result information including information in which location information which is information which specifies a location in the Web-content of the element including the content instruction information including a figure-symbol-character and the element concerned are made to correspond, and
linking, for each element which is included in the examination result information generated, the one or more rule identifiers specified corresponding to the class of the markup tag which the element includes to the element concerned, and
the Web-content conversion unit specifies, for each element of the Web-content corresponding to the element included in the examination result information to which the Web-content analysis unit made the rule identifier correspond, and based on the rule identifier which is made to correspond to the element, the replacement information of the element concerned.

2. (canceled)

3. The Web-content conversion apparatus which is the Web-content conversion apparatus according to claim 1 wherein
the Web-content conversion apparatus further comprising:
a relevant part output unit which links and outputs the rule identifier, which is made to correspond respectively to each element included in the examination result information to which the Web-content analysis unit made the rule identifier correspond, to the each element respectively; and
a conversion method selection unit which, for each element included in the examination result information, receives an identifier selection result which is information which shows either of the rule identifier which is made to correspond to the element and links the rule identifier which is shown by the received identifier selection result to the corresponding element concerned; and wherein
the Web-content conversion unit specifies, for each element of the Web-content corresponding to the element included in the examination result information to which the conversion method selection unit made the rule identifier correspond, and based on the rule identifier which is made to correspond to the element, the replacement information of the element concerned.

4. The Web-content conversion apparatus which is the Web-content conversion apparatus according to claim 1, wherein
the figure-symbol-character conversion correspondence relation storage unit links and stores the figure-symbol-character and a conversion candidate group which includes a plurality of character strings after conversion of the figure-symbol-character,
the Web-content analysis unit, in case a figure-symbol-character is included in the content instruction information, reads the conversion candidate group which is made to correspond to the figure-symbol-character from the figure-symbol-character conversion correspondence relation storage unit, and
the Web-content conversion unit, for each element included in the Web-content and including the content instruction information including the figure-symbol-character, by using the replacement information which is the information which added at least one character string after conversion included in the conversion candidate group the Web-content analysis unit read based on the figure-symbol-character which is included in the content instruction information included in the element to at least part of the element concerned, and by replacing the element concerned, converts the Web-content to the Web-content after conversion.

5. The Web-content conversion apparatus which is the Web-content conversion apparatus according to claim 3, wherein
the figure-symbol-character conversion correspondence relation storage unit links and stores the figure-symbol-character and the conversion candidate group which includes a plurality of character strings after conversion of the figure-symbol-character,
the Web-content analysis unit, in case a figure-symbol-character is included in the content instruction information, reads the conversion candidate group which is made to correspond to the figure-symbol-character from the figure-symbol-character conversion correspondence relation storage unit,
the Web-content analysis unit, for each element which is included in the examination result information generated, links the rule identifier specified corresponding to the class of the markup tag which the element includes and the conversion candidate group which is read based on the figure-symbol-character which is included in the content instruction information included in the element concerned to the element concerned respectively,
the relevant part output unit, for each element which is included in the examination result information in which the Web-content analysis unit made the rule identifier and the conversion candidate group correspond, links and outputs respectively the rule identifier and the conversion candidate group which is made to correspond to the element to the element concerned,
the conversion method selection unit, for each element included in the examination result information,
receives a character string selection result which is information which shows either of the character string after conversion which is included in the conversion candidate group which is made to correspond to the element concerned together with the identifier selection result respectively, and links the rule identifier which is shown by the identifier selection result corresponding to the element concerned and the character string after conversion shown by the character string selection result corresponding to the element concerned to the element concerned respectively, and
the Web-content conversion unit, for each element which the Web-content corresponding to the element which is included in the examination result information in which the conversion method selection unit made the rule identifier and the character string after conversion correspond includes, and based on the rule identifier which is made to correspond to the element, by specifying the replacement information which is the information which added at least one character string after conversion which is included in the conversion candidate group which the Web-content analysis unit read based on the figure-symbol-character which is included in the content instruction information included in the element concerned to at least part of the element concerned, and by replacing the element concerned using the replacement information concerned, converts the Web-content to the Web-content after conversion.

6. The Web-content conversion apparatus which is the Web-content conversion apparatus according to claim 1, wherein
the replacement information is the information which, among the elements, replaced the figure-symbol-character which is included in the content instruction information included in the element concerned by the character string after conversion which the Web-content analysis unit read based on the figure-symbol-character concerned.

7. The Web-content conversion apparatus which is the Web-content conversion apparatus according to claim 1, wherein
the replacement information is the information which, among the elements, added to the figure-symbol-character which is included in the content instruction information included in the element concerned the character string after conversion which the Web-content analysis unit read based on the figure-symbol-character concerned.

8. The Web-content conversion apparatus which is the Web-content conversion apparatus according to claim 1, wherein
the replacement information is the information which, as an attribute value of an attribute for adding supplementary information to the element, set the character string after conversion which the Web-content analysis unit read based on the figure-symbol-character which is included in the content instruction information which the element concerned includes to the element concerned.

9. The Web-content conversion apparatus which is the Web-content conversion apparatus according to claim 1, wherein
the replacement information is the information which, among the elements, added to the figure-symbol-character which is included in the content instruction information included in the element concerned the character string after conversion which the Web-content analysis unit read based on the figure-symbol-character concerned as the information used for displaying it as a ruby of the figure-symbol-character concerned.

10. A Web-content conversion method comprising:
linking and storing in a storage unit a figure-symbol-character which is a symbol-character representing a figure and a character string after conversion which is a character string representing the meaning of the figure-symbol-character concerned;
among elements which are included in an inputted Web-content, and in case a figure-symbol-character is included in content instruction information which shows contents of the element including a predetermined markup tag or an attribute value of an attribute which the predetermined markup tag includes, reading the character string after conversion which is made to correspond to the figure-symbol-character concerned from the storage unit; and
for each element included in the Web-content and including the content instruction information including a figure-symbol-character, by using replacement information which is information which added the character string after conversion read based on the figure-symbol-character which is included in the content instruction information included in the element to at least part of the element, and by replacing the element concerned, converting the Web-content to Web-content after conversion, wherein
when reading the character string after conversion,
storing rule selection information which is information which made a class of a markup tag and a rule identifier which identifies a method to convert the Web-content correspond,
specifying, for each element including the content instruction information which is included in the Web-content inputted, the class of the markup tag which the element includes,
specifying respectively the rule identifier which is made to correspond to the class specified based on the rule selection information,
generating examination result information including information in which location information which is information which specifies a location in the Web-content of the element including the content instruction information including a figure-symbol-character and the element concerned are made to correspond, and
linking, for each element which is included in the examination result information generated, the one or more rule identifiers specified corresponding to the class of the markup tag which the element includes to the element concerned, and
when converting the Web-content to Web-content after conversion, for each element of the Web-content corresponding to the element included in the examination result information to which the Web-content analysis unit made the rule identifier correspond, and based on the rule identifier which is made to correspond to the element, specifying the replacement information of the element concerned.

11. A non-transitory recording medium which stored a program which makes a computer execute processing comprising:
processing which links and stores in a storage unit a figure-symbol-character which is a symbol-character representing a figure and a character string after conversion which is a character string representing the meaning of the figure-symbol-character concerned;
processing which, among elements which are included in an inputted Web-content, and in case a figure-symbol-character is included in content instruction information which shows contents of the element including a predetermined markup tag or an attribute value of an attribute which the predetermined markup tag includes, reads the character string after conversion which is made to correspond to the figure-symbol-character concerned from the storage unit; and
processing which, for each element included in the Web-content and including the content instruction information including a figure-symbol-character, by using replacement information which is information which added the character string after conversion read based on the figure-symbol-character which is included in the content instruction information included in the element to at least part of the element, and by replacing the element concerned, converts the Web-content to Web-content after conversion, wherein
in processing which reads the character string after conversion,
storing rule selection information which is information which made a class of a markup tag and a rule identifier which identifies a method to convert the Web-content correspond,
specifying, for each element including the content instruction information which is included in the Web-content inputted, the class of the markup tag which the element includes,
specifying respectively the rule identifier which is made to correspond to the class specified based on the rule selection information,
generating examination result information including information in which location information which is information which specifies a location in the Web-content of the element including the content instruction information including a figure-symbol-character and the element concerned are made to correspond, and
linking, for each element which is included in the examination result information generated, the one or more rule identifiers specified corresponding to the class of the markup tag which the element includes to the element concerned, and
in processing converts the Web-content to Web-content after conversion,
for each element of the Web-content corresponding to the element included in the examination result information to which the Web-content analysis unit made the rule identifier correspond, and based on the rule identifier which is made to correspond to the element, specifying the replacement information of the element concerned.

12. The Web-content conversion apparatus which is the Web-content conversion apparatus according to claim 1, comprising:
a voice read aloud unit which outputs the Web-content after conversion by voice, wherein
the voice read aloud unit outputs information which the character string after conversion shows by voice.
